(19) United States
(12) Patent Application Publication
(10) Pub. No.: US 2020/0325025 A1
(43) Pub. Date: Oct. 15, 2020

(54) Devices and Methods for Thin Film Chemical Processing

(71) Applicant: 2D FLUIDICS PTY LTD, Nedlands (AU)

(72) Inventors: Colin Raston, Netherby (AU); Kasturi Vimalanathan, Sturt (AU); Darryl Bruce Jones, Underdale (AU); Ibrahim Khalaf M Alsulami, Sturt (AU); Thaar Muqhim D Alharbi, Warradale (AU)

(21) Appl. No.: 16/763,523

(22) PCT Filed: Nov. 15, 2018
(86) PCT No.: PCT/AU2018/051222

§ 371 Date: May 12, 2020

(30) Foreign Application Priority Data
Nov. 15, 2017 (AU) 2017904624

(51) Int. Cl. C01B 32/198; C01B 32/19; C01B 32/18; C01B 32/156; C01B 32/159; C01B 32/168; C01B 21/064; C01B 25/00; B01J 19/18; B01J 19/00

(52) U.S. Cl. CPC C01B 32/198; C01B 32/19; C01B 32/18; C01B 32/156; C01B 32/159; B82Y 40/00; C01B 21/0648; C01B 25/003; B01J 19/1887; B01J 19/0093; C01B 2202/02; C01B 32/168

(57) ABSTRACT

Producing nanostructure materials in a thin film reactor (TFR) from starting material of inorganic or organic material of layered or two dimensional (2D) structure or inorganic material transformed in situ into 2D inorganic material, or single walled carbon nanotubes (SWCNTs), and a solvent or liquid phase. The TFR can be a vortex fluidic device (VFD) or a device with spaced first and second fluid contact surfaces, which can be conical, for relative rotation to generate shear stress in the thin film therebetween. A liquid supply means delivers a liquid between the first and second fluid contact surfaces. The composition can be exposed to laser energy. The thin film reactor can form graphene, graphene oxide, scrolls, tubes, spheres or rings of the layered or 2D material.

### TECHNICAL FIELD

The present disclosure relates to the use of thin film processing technology to develop or create nanomaterials and/or nanomaterial structures, such as, but not limited to, the exfoliation of graphene from graphite, the creation of scrolls of graphene from graphite, the creation of scrolls of preformed graphene oxide (GO), the synthesis of graphene oxide, and the formation of continuous rings of single walled carbon nanotubes (SWCNTs).

The present disclosure includes purification using thin film processing technology, such as for graphite, graphene and graphene oxide.

Methods are disclosed for the exfoliation, purification, structure creation and/or functionalisation of nanomaterials, such as graphene directly from graphite flakes, under continuous flow processing conditions without the use of toxic and persistent chemicals, and surfactants.

### BACKGROUND

Graphene is the most recently isolated carbon nanostructure, representing a conceptually new class of materials that is only one atom thick and is a building block for other carbon nanomaterials with different dimensionalities. Graphene can be wrapped up into 1D nanotubes or stacked into 3D graphite.

In 2004, Andre Geim and Konstantin Novoselov mechanically exfoliated single layered graphene sheets from bulk graphite using the ‘scotch tape’ method.

Since then, graphene has been the most enticing nanomaterial, being extensively explored in terms of developing new techniques to exfoliate single layered sheets, precisely control the morphology of the nanomaterial, the formation of hybrid materials amongst others, to be used in a wide range of applications. Its extraordinary properties include excellent electrical, thermal, mechanical, electronic and optical properties, with a high specific surface area, high chemical stability, high optical transmittance, high elasticity, high porosity, biocompatibility and it has a tuneable band gap.

Graphene has other remarkable properties including (i) half-integer room temperature quantum Hall effect, (ii) long range ballistic transport, (iii) almost ten times greater electron mobility than that of silicon (Si), behaves as a massless relativistic quasi particle charge carrier (Dirac fermion), and (v) quantum confinement giving rise to a finite band gap and Coulomb blockade effect.

Graphene is an example of a zero-bandgap conductor with approximately linear electron dispersion at the vicinity of the Fermi level at two points in the Brillouin zone (BZ). The negligible fraction of single layered graphene sheets was experimentally confirmed to consist of charge carriers that were indeed massless Dirac fermions, with carrier mobilities up to 200,000 cm² V⁻¹ s⁻¹.

Applications of graphene are many and varied, including high frequency electronics, conductive coatings, composite fillers, energy generation, storage and bioapplications.

Graphene is also an ideal material for low cost electrode material in solar cells, batteries and sensors and as a transparent electrode in a liquid crystal device.

Mechanical exfoliation was the first method discovered to generate single layer graphene, as a form of micromechanical cleavage. This so called ‘Scotch tape’ method, uses cellophane tape to peel off graphene layers from highly oriented pyrolytic graphite flakes, as defect free single layered graphene sheets. Defect free single, and also bi-layer, graphene sheets, have been fabricated using ‘top down’ and ‘bottom up’ approaches. The latter involves chemical and physical processes to form the 2D networks from small molecular blocks used in chemical vapour deposition method (CVD), molecular beam epitaxy or anodic bonding.

The ‘top down’ approach involves breakdown of bulk graphitic material into graphene sheets, usually achieved by mechanical exfoliation, ball-milling, electrochemical exfoliation, oxidative intercalation exfoliation, liquid phase exfoliation and the reduction of graphene oxide.

Although, the ‘bottom up’ approach has made significant contributions towards producing graphene sheets, the processes are high costing with the issue of scalability still a major challenge.

On the contrary, the ‘top down’ approach using liquid phase exfoliation (LPE) shows greater potential to produce large quantities of defect free graphene. Overcoming the non-covalent van der Waals interactions arising from the overlap of π orbital is required for exfoliation, and for a single sheet this has a high energy requirement. The ability to achieve this depends on a number of factors including the choice of solvent system coupled with shear forces to provide energy sufficient to balance the solvent-graphene interaction and intercalation of molecules or functionalization of the bulk graphite.

For exfoliation in a liquid medium, the choice of solvent is pivotal, as it must have a high affinity towards the carbon surface. Taking this into consideration, only a number of solvents have been effective, namely N-methyl-pyrollidinone (NMP), N,N-dimethylformamide (DMF), benzyl benzoate and γ-butyrolactone.

Avoiding restacking of graphene sheets post exfoliation, arising from the strong π-π interactions between the layers of the bulk material is a common challenge to overcome. It can be circumvented using surface-active molecules or intercalating molecules such as phosphonated calixarenes, lignin molecules, and porphyrins.

Graphite is most often intercalated with oxidizing acids or molecular oxidants as an interlayer of both neutral and ionized guest species.

The energetics of intercalation describes the complementing nature of both molecules with the energy required for exfoliation, balanced by the electron affinity and lattice energy of the ionic guest molecule.

Neutral molecules such as Br₂, AsF₅ or FeCl₃ stabilize the exfoliated sheets by screening the repulsion between the negative charged guest species.

Although the exfoliation via oxidization methods has high yielding outcomes, the functionalization of hydroxyls and epoxides on the surface of the sheets and intercalation molecules disrupts the electronic structure; defects on the basal planes also disrupts its electronic properties.

Thus, there is a need for improved methods and devices for production of nanomaterials.

It has been found particularly desirable to develop high yielding synthetic processes to produce suspensions of pristine defect free single and few-layer nanomaterials, such as graphene sheets and graphene scrolls.

### SUMMARY

In a first aspect, provided herein is a process for exfoliating inorganic or organic materials having a graphitic like layered structure, the process comprising:
introducing a composition comprising starting inorganic or organic materials having a graphitic like layered structure and a solvent or liquid phase to a thin film reactor under conditions to form a dynamic thin film and generate shear stress within the thin film;
optionally, exposing the composition in the thin film reactor to energy from an energy source; and
processing the composition in the thin film reactor under conditions to form exfoliated inorganic or organic materials.

In some embodiments of the first aspect, the process further includes processing the composition in the thin film reactor under conditions to form scrolls of the graphitic like layered structure.

In some embodiments of the first aspect, the inorganic or organic materials having a graphitic like layered structure are selected from the group consisting of graphite, graphitic boron nitride, black phosphorus, MXene, MoS₂ and WS₂, antimonene, and clay materials. In these embodiments, the exfoliated inorganic or organic materials recovered include graphene sheets, boron nitride sheets, phosphorus black sheets, MXene sheets, graphene scrolls, and boron nitride scrolls.

In a second aspect, provided herein is a process for producing graphene oxide materials, the process comprising
introducing a composition comprising graphite and an oxidant solution to a thin film reactor under conditions to form a thin film and impart shear stress on the composition;
exposing the composition in the thin film reactor to energy from an energy source; and
processing the composition in the thin film reactor under conditions to form graphene oxide.

In some embodiments of the second aspect, the oxidant is an aqueous peroxide solution. In some of these embodiments, the aqueous peroxide solution is an aqueous hydrogen peroxide solution.

In some embodiments of the second aspect, the process further includes recovering a reaction mixture comprising graphene oxide from the thin film reactor.

In some embodiments of the second aspect, the process further includes recovering graphene oxide from the reaction mixture.

In a third aspect, provided herein is a process for forming continuous rings of single walled carbon nanotubes (SWCNTs), the process comprising:
introducing a composition comprising starting SWCNTs of a predetermined length and a solvent or liquid phase to a thin film reactor under conditions to form a dynamic thin film and generate shear stress within the thin film;
optionally, exposing the composition in the thin film reactor to energy from an energy source; and
processing the composition in the thin film reactor under conditions to form continuous toroidal rings of SWCNTs.

In some embodiments of the third aspect, the process further includes recovering a reaction mixture comprising continuous toroidal rings of SWCNTs from the thin film reactor.

In some embodiments of the second aspect, the process further includes recovering continuous toroidal rings of SWCNTs from the reaction mixture.

In some embodiments of the first to third aspects, the energy source is a laser. In some of these embodiments, the laser emits light at a wavelength of 1064 nm. In some of these embodiments, the laser power is from about 260 mJ to about 650 mJ. In some of these embodiments, the laser power is pulsed.

In some embodiments of the first to third aspects, the thin film reactor is a vortex fluidic device (VFD). In some other embodiments of the first to third aspects, the thin film reactor is a device of the fourth aspect.

Another aspect of the present invention provides a process for producing nanostructure materials in a thin film reactor from inorganic or organic material having a layered or two dimensional (2D) structure or from inorganic material transformed in situ into 2D inorganic material or from single walled carbon nanotubes (SWCNTs), the process comprising:
providing in the thin film reactor a composition including:
an inorganic or organic starting material having a layered or 2D structure or single walled carbon nanotubes (SWCNTs), or
transforming in situ a said inorganic material into a said 2D inorganic starting material,
and a solvent or liquid phase;
forming a dynamic thin film of the composition in the thin film reactor;
generating shear stress within the thin film;
under controlled conditions applied to the thin film of the composition within the thin film reactor, forming a desired nanostructure material.

The starting material may include graphite or graphitic material.

The nanostructure material may include graphene or graphene oxide.

The process may include transforming the inorganic starting material into a 2D or layered inorganic material in situ in the thin film device prior to or during the process steps of forming the desired nanostructure material.

The process may include processing the composition in the thin film reactor under conditions to form scrolls, tubes, spheres or rings of the layered or 2D material.

The inorganic or organic material may have a graphitic like layered structure selected from the group consisting of graphite, graphitic boron nitride, black phosphorus, MXene, MoS₂ and WS₂, antimonene, and clay materials.

The inorganic or organic material may have a graphitic like layered structure that is formed under processing, as in the processing of tellurium.

The process may include exposing the composition in the thin film reactor to energy from an energy source, and processing the composition in the thin film reactor under conditions to form exfoliated inorganic or organic materials.

The energy source can be or include a laser. Preferably the laser emits light at a wavelength of 1064 nm. Laser power may be from about 260 mJ to about 650 mJ.

The process may further include recovering a reaction mixture including exfoliated inorganic or organic material, scrolls, tubes, spheres or rings of the 2D or layered material from the thin film reactor.

The process may further include recovering the exfoliated inorganic or organic material, scrolls, tubes, spheres or rings of the 2D or layered material from the reaction mixture.

The solvent or liquid phase may include an oxidant. The oxidant may include an aqueous peroxide solution.

The starting material may include processing single walled carbon nanotubes (SWCNTs).

The process may include introducing the composition including the SWCNTs and the solvent or liquid phase to the thin film reactor under conditions to form the dynamic thin film and generate shear stress within the thin film;
and
processing the composition in the thin film reactor under the conditions to form continuous toroidal rings of the SWCNTs.

The process may further include recovering a reaction mixture including the continuous toroidal rings of the SWCNTs from the thin film reactor.

The process may further include recovering the continuous toroidal rings of the SWCNTs from the reaction mixture.

The starting material may include black phosphorus and the resulting nanostructure material phosphorene.

The process may further include exfoliation of the 2D or layered starting material within the thin film reactor.

The exfoliation can occur simultaneously with creation of the desired nanostructure material.

The thin film reactor employed in the process may be a vortex fluidic device (VFD) or a device including a first fluid contact surface and a second fluid contact surface spaced from the first fluid contact surface by a distance corresponding to a desired thin-liquid film thickness and rotatable with respect to the first fluid contact surface about an axis of rotation, a liquid supply means configured to deliver a liquid between the first fluid contact surface and the second fluid contact surface so that, in use, the liquid contacts the first and second fluid contact surfaces and forms a thin liquid film of desired thickness therebetween, and relative rotation between the first and second fluid contact surfaces drives the liquid away from the axis of rotation and creates shear stress within the thin liquid film.

In a fourth aspect, provided herein is a device for forming thin-liquid films under high shear stress, the device comprising a first fluid contact surface and a second fluid contact surface spaced from the first fluid contact surface by a distance corresponding to a desired thin-liquid film thickness and rotatable with respect to the first fluid contact surface about an axis of rotation, a liquid supply means configured to deliver a liquid to the first fluid contact surface and/or the second fluid contact surface so that, in use, the liquid contacts the first and second fluid contact surfaces and forms a thin liquid film of desired thickness there between and relative motion between the first and second fluid contact surfaces drives the liquid away from the axis of rotation and creates shear stress within the thin liquid film.

In certain embodiments of the fourth aspect, the first fluid contact surface is a substantially planar surface on a stationary base of the device.

The liquid may be forced outwards and upwards, following a helical path, between the first and second fluid contact surfaces.

In certain embodiments of the fourth aspect, the second fluid contact surface is a substantially planar surface on a rotor of the device.

The first fluid contact surface may be on a stationary base of the device and the second fluid contact surface on a rotor of the device.

Preferably the rotor includes at least one blade. The at least one blade may diverge from the second fluid contact surface inward of the rotor toward the axis of rotation.

The rotor may have at least one opening through a wall thereof for the liquid to flow from the space to the second fluid contact surface.

The at least one opening may be provided by peeling or divergence of a respective wall section from the wall.

The respective wall section may include a curved or angled wall section projecting into an interior of the rotor of the wall

The second contact surface may have a cone or frusto-conical profile. The first contact surface may have a hollow cone or frusto-conical profile to receive the second fluid contact surface therein at the spaced distance.

The liquid supply means may be configured to provide the liquid into a space between the axis of rotation and the second fluid contact surface.

The liquid may be delivered into an area adjacent the axis of rotation. The liquid supply means may include an injector.

The device may further include at least one flowpath for receiving the liquid driven from between the first fluid contact surface and the second fluid contact surface.

The first contact surface and the second contact surface may be maintained at a distance of 50 μm to 500 μm, preferably between 75 μm and 250 μm and more preferably between 100 μm and 200 μm.

The first fluid contact surface and/or the second fluid contact surface may be at an angle of between 0° and 90° with respect to the axis of rotation. The angle may be between 20° and 60° from the axis of rotation. Preferably, the angle may be substantially 45° from the axis of rotation.

Relative motion of the first fluid contact surface and the second fluid contact surface may be between 100 rpm and 10,000 rpm, but not limited to such speeds. The first fluid contact surface may be stationary and the second fluid contact surface may rotate about the axis of rotation. The relative motion may be between 500 rpm and 5000 rpm, but not limited to such speeds.

The thin-liquid film(s) within the device may include a composition containing an inorganic or organic material having a layered or 2D structure and a solvent or liquid phase.

The liquid can include a composition of inorganic or organic material having a layered or two dimensional (2D) structure or inorganic material subsequently transformed in situ in the device into 2D inorganic material or single walled carbon nanotubes (SWCNTs).

A further aspect of the present invention provides nanostructure materials formed by a process according to one or more embodiments of the present invention.

Nanostructure materials fabricated/formed according to a process of the present invention may include scrolls, tubes, spheres and rings.

Nanostructure materials fabricated/formed according to a process of the present invention may include graphene, graphene oxide, phosphorene, SWCNTs.

### BRIEF DESCRIPTION OF DRAWINGS

Embodiments of the present disclosure will be discussed with reference to the accompanying drawings wherein:

FIG. 1 shows an exploded view of a thin film processing device according to embodiments of the disclosure;

FIG. 2 shows a schematic of a thin film processing device according to embodiments of the disclosure. (a) The rotor, showing blade positions around the rotation axis. (b) A cross section of the assembly, with an inset showing the blade base spacing, d;

FIG. 3 shows SEM images of graphite processed through a thin film processing device according to embodiments of the disclosure at 4000 rpm (30 passes through device, 10 mg Graphite/mL; Solvent Water);

FIG. 4 shows SEM images of graphite processed through a thin film processing device according to embodiments of the disclosure at 7000 rpm (30 passes through device, 10 mg Graphite/mL; Solvent Water);

FIG. 5 shows SEM images of graphite processed through a thin film processing device according to embodiments of the disclosue at 7000 rpm (30 passes through device, 10 mg Graphite/mL; Solvent H₂O₂ (30% w/v); samples centrifuged) showing a delamination/fracturing of graphite sheets. A change in morphology at the edges is observed;

FIG. 6 shows SEM images of exfoliated graphene sheets post vortex fluidic device (VFD) processing;

FIG. 7 shows: (a-h) AFM images of the exfoliated graphene sheets post VFD processing, (i) Histogram of the thickness of graphene sheets measured by AFM (a distribution of 550 graphene sheets). The graphene sheets had an average thickness of 6-7 nm;

FIG. 8 shows Raman spectra of the graphite ore and graphene sheets afforded in the VFD;

FIG. 9 shows SEM images of graphene sheets exfoliated in the VFD in the presence of a IR lamps (1000 W) as an alternative to the pulsed Nd:YAG laser;

FIG. 10 shows SEM images of graphene sheets processed in the VFD with a pulsed Nd:YAG laser (λ=1064 nm); laser power of ˜260 mJ directed to the rapidly rotating tube. The solvent used was H₂O₂;

FIG. 11 shows AFM images of graphene sheets processed in H₂O₂ in the VFD. The graphene sheets were observed to be approximately 7-20 nm in thickness;

FIG. 12 shows XPS analysis of the graphite flakes processed in 30% H₂O₂ in the VFD. Laser power ˜260 mJ;

FIG. 13 shows Raman spectra of the (i) graphite ore and (ii) graphene processed in the VFD using 30% aqueous H₂O₂ in the presence of a simultaneous pulsed laser with a power of ˜260 mJ;

FIG. 14 shows SEM images of exfoliated graphene sheets using 30% aqueous H₂O₂ in the presence of a simultaneous pulse laser at a power Of 450 mJ in the VFD;

FIG. 15 shows Raman spectra of the (i) graphite ore and (ii) graphene processed in the VFD using 30% aqueous H₂O₂ in the presence of a simultaneous pulsed laser with a power of ˜450 mJ;

FIG. 16 shows SEM images of exfoliated graphene sheets using 30% aqueous H₂O₂ in the presence of a simultaneous pulsed laser at a power of 650 mJ in the VFD;

FIG. 17 shows AFM images of graphite processed in the VFD in 30% H₂O₂ using a laser power of 650 mJ. Average height thickness of the sheets were approximately 10-30 nm;

FIG. 18 shows Raman spectra of the (i) graphite ore and (ii) graphene processed in the VFD using 30% aqueous H₂O₂ in the presence of a simultaneous pulsed laser with a power of ˜650 mJ;

FIG. 19 shows SEM images of exfoliated boron nitride sheets dispersed in water, formed in water in the VFD at a rotational speed of 6000 rpm, inclination angle −20°; flow rate 0.7 mL/min;

FIG. 20 shows: (a) a schematic of a VFD which has optimized θ=45° and ω=7500 rpm for the fabrication of graphene scrolls from graphite flakes in a 20 mm OD borosilicate glass tube; and (b) graphite dispersed in toluene (0.5 mg/mL) which was added to the tube along with water at a 1:1 ratio (total volume in the tube 1.0 mL) under the confined mode of operation;

FIG. 21 shows SEM images of the graphene scrolls formed from graphite in the VFD over 30 min; graphite concentration in toluene 0.5 mg/mL, 1 mL of 1:1 toluene and water, θ=45°, ω=7.5k rpm;

FIG. 22 shows AFM phase images of the graphene scrolls formed under the same conditions in FIG. 20;

FIG. 23 shows: (a-b) TEM images of the graphene scrolls; (c-d) HRTEM images with the selected area electron diffraction (SAED) pattern (inset); scroll formation using the conditions in FIG. 20;

FIG. 24 shows: (a) Raman spectroscopy and (b) XPS C1s spectra of the as received graphite flakes and the graphene scrolls formed at the optimised conditions in FIG. 20;

FIG. 25 shows AFM height images of h-BN scrolls fabricated in the VFD at an inclination angle of θ=−45° and a rotational speed of 6000 rpm;

FIG. 26 shows AFM height images of the h-BN scrolls formed in the VFD and its associated height profile between 10 to 40 nm;

FIG. 27 shows SEM images of the h-BN scrolls formed in the VFD at an inclination angle of −45° and a rotational speed of 6000 rpm;

FIG. 28 shows SEM images of the bulk black phosphorus dispersed in IPA pre-VFD processing;

FIG. 29 shows AFM height images of the exfoliated phosporene obtained after processing in the VFD with a thickness of approximately 2-6 nm;

FIG. 30 shows SEM images of graphene oxide scrolls formed in the VFD under continuous flow mode coupled with irradiated laser (250 mJ), graphene oxide concentration in water 0.2 mg/mL, θ 45°, ω 4000 rpm;

FIG. 31 shows: a) AFM image; and b-c) TEM images of the graphene oxide scrolls formed the VFD under continuous flow mode coupled with irradiated laser (250 mJ), graphene oxide concentration in water 0.2 mg/mL, θ=45°, ω=4000 rpm;

FIG. 32 shows SEM images of graphene spheres produced by using a vortex fluidic device VFD under continuous flow, in toluene and DMF in the presence of fullerene C₆₀;

FIG. 33 shows images of scrolling of graphite produced using a vortex fluidic device VFD;

FIG. 34 shows SEM images of as received MXene;

FIG. 35 shows SEM images of exfoliated MXene sheets formed in the VFD;

FIG. 36 shows AFM images of SWCNT rings, formed from sliced SWCNTs (680 nm in length) in the VFD, (a-c) both ends of SWCNTs fused to form rings (d) height profile for the ring in (b). (e-f) continuous rings of SWCNT, from sliced SWCNTs (680 nm in length) with 100 mJ Laser power, (g) Height profile for ring in (f), (h-j) TEM images of SWCNTs rings, which are exactly the same samples of (e-f).

FIG. 37 shows a schematic illustration of a procedure for fabricating/creating graphene oxide scrolls (GOS) from GO sheets.

FIG. 38 shows features a) to k) relating to formation of GOS from GO using a VFD.

### DESCRIPTION OF EMBODIMENTS

Processing to create desired nanomaterial structures can be carried out using a thin film processing device (TFPD). A device such as a vortex fluidic device (VFD), as described in more detail later, can be used.

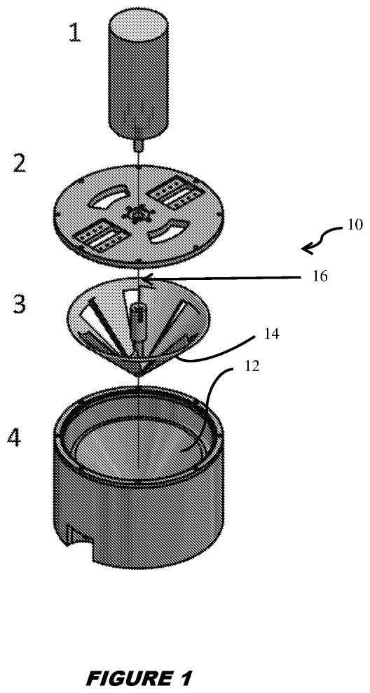

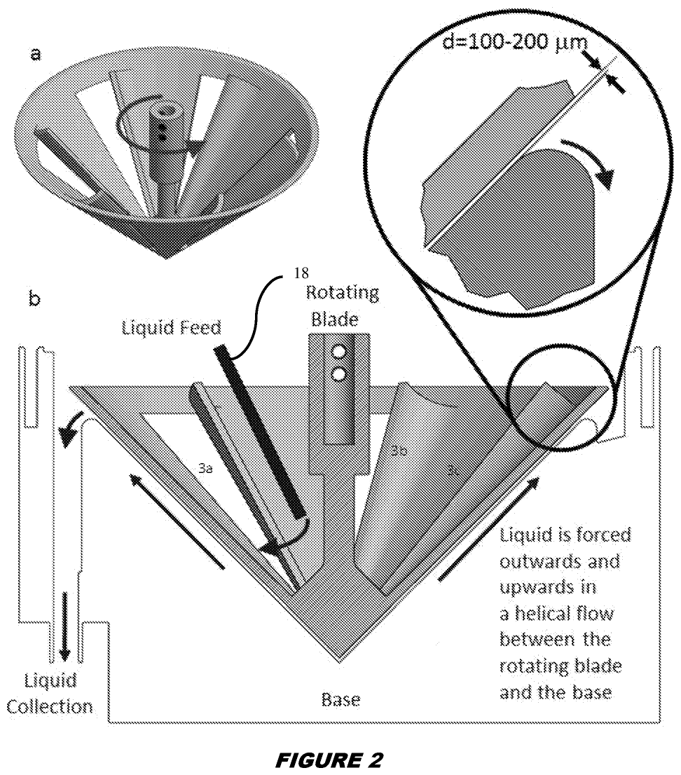

Processes described herein and other thin film processes can be carried out using the thin film processing device, an embodiment of which is shown in FIGS. 1 and 2.

Shown in FIGS. 1 and 2 is a device 10 for forming thin-liquid films under high shear stress. The device 10 has a first fluid contact surface 12 and a second fluid contact surface 14 spaced from the first fluid contact surface by a distance (d) corresponding to a desired thin-liquid film thickness. The second fluid contact surface 14 is rotatable with respect to the first fluid contact surface 12 about an axis of rotation 16.

A liquid injector 18 is configured to deliver a liquid to the first fluid contact surface 12 and/or the second fluid contact surface 14 in an area adjacent the axis of rotation 16 so that, in use, the liquid contacts the first and second fluid contact surfaces and forms a thin liquid film of desired thickness there between and relative rotation between the first and second fluid contact surfaces drives the liquid away from the axis of rotation 16 and creates shear stress within the thin liquid film.

The device 10 has a stationary base (4), and a rapidly rotating rotor (3). The base (4) has an inverse conical cavity with an apex angle of 90°. The apex angle can vary between 0° (tubular reactor design) and 180° (Flat plate reactor). The rotating rotor (3) can include a shaft which couples to a variable high speed motor (rotating at speeds of up to 10000 rpm or more).

The rotor has a variable number of blade sections, conical in nature with a same apex to that of the base (3c). Each conical section is preceded by a curved or inclined plane section (3b) in the direction of rotation (which can be clockwise/counter clockwise). The blade position can be adjusted to control the gap between the blade and base (through a mounter mount/spacer combination (2)).

The apex angle may be adjusted to change the film thickness as a function of the radial distance from the rotation axis.

Alternatively, the blade or base surfaces can also be curved, or be structured, to change the film thickness as a function of the radius or introduce other perturbations to the film.

Within the device 10, a mix of a fluid and one or more gases, such as air, is forced through the void in the rotor (3a) by the fan extrusion (3b) so that it experiences high sheer stress between the sub 200 micron gap between the conical rotor section (3c) and the base (4). Here the high air/vapour mass transfer of the fluid is unique because other rotor stator combinations do not allow the air draw into the fluid through the high surface volume ratio of the fluid.

Liquid is pumped/injected into the device via the liquid injector 18, that may be in the form of one or more jets at the top, or fed from a hole at the apex of the conical cavity in the base.

As the blade rotates, the curved/inclined section of the blade forces the air-liquid mix down and radially outwards through the gap created between the rotor and base (4).

Between the blade and base, the fluid is thinner than the gap, d, and the fluid experiences high shear stress created between the stationary and rotating surfaces.

Another key feature of the device 10 is that the shear induced stresses within the fluid vary, being highest when the rotor blade contacts the film and allowing the fluid to relax after. It is important to note that this differs from other processing technologies and that the relaxation allows turbulent mixing in the wake of the rotors passing.

Field effects can be incorporated into the device, such as but not limited to introducing laser radiation, heating and cooling of the base, putting electric fields across the base and rotor.

The rotor can be made of metal (titanium/stainless steel, but not limited to) so that it is chemically inert. It can also employ a glass, metal combination so that EM radiation can be focussed into high stress regions.

An electric potential can be placed across the rotor (3) and base (4).

The base (4) can also be made of metal (titanium/stainless steel) or glass, but not limited to, so that once again EM radiation can be directed into the shear stressed fluid.

Air/vapour plasmas can be created in the air space above the fluid and directed into the thin film. The base can also be temperature controlled.

The liquid processed in the device 10 can be a single solution, mixture of precursors or particles suspended in solution.

The device 10 can be used to create various forms/structures of nanomaterials. For example, the device 10 is useful in the exfoliation, purification and functionalisation of graphite flakes and other 2D materials:
To produce graphene sheets with a thickness ranging between 5-10 nm;
Oxidation of the surface of graphene using a benign solvent system of aqueous hydrogen peroxide (30%);
Controlling the oxidation on the surface of the graphene sheets;
Using an IR lamp as an alternative light source for the processes;
Creation of graphene scrolls directly from graphite flakes;
Creation of graphene scrolls in water;
Exfoliation of h-boron nitride sheets and other 2D laminar materials; and
Exfoliation of black phosphorus.

Thus, the present disclosure provides a method for creating thin-liquid films (thickness<200 μm) under high shear stress in a device 10 or a VFD, and using this method to fabricate various forms of nanomaterials.

The device 10 can also be used in materials processing through:
Changing the size and thickness of materials;
Changing the morphology of the materials;
Controlling the size of droplets in liquid-liquid dispersions, homogenization;
Controlling chemical reactivity and selectivity;

As mentioned, another possible reactor that can be used in the processes described herein is a vortex fluidic device (VFD). Details of the VFD are described in published United States patent application US 2013/0289282, the entire contents of which are incorporated herein by reference.

The VFD is a versatile microfluidic platform with a number of applications, including slicing of single, double and multi-walled carbon nanotubes, protein folding, enhancing enzymatic reactions, protein immobilization, fabricating/creating C₆₀ tubules using water as an anti-solvent against toluene, exfoliation of graphite and boron nitride, growth of metals, including rare, precious and semi-precious metals, such as palladium and platinum, nanoparticles on carbon nano-onions, probing the structure of self-organized systems, and controlling chemical reactivity and selectivity.

Briefly, the VFD is a thin film tube reactor having a tube rotatable about its longitudinal axis by a motor.

The tube is substantially cylindrical or comprises a portion that is tapered. The motor can be a variable speed motor for varying the rotational speed of the tube and can be operated in controlled set frequency and set change in speed.

A generally cylindrical tube is particularly suitable but it is contemplated that the tube could also take other forms and could, for example, be a tapered tube, a stepped tube comprising a number of sections of different diameter, and the like.

The tube can be made of any suitable material including glass, metal, plastic, ceramic, and the like. In certain embodiments, the tube is preferably made from borosilicate.

Optionally, the inner surface of the tube can comprise surface structures or aberrations.

In one or more embodiments, the tube can be or include a pristine borosilicate NMR glass tube which has an internal diameter typically 17.7±0.013 mm.

The tube is preferably situated on an angle of incline relative to the horizontal of above 0 degrees and less than 90 degrees. In certain embodiments, the tube may be situated on an angle of incline relative to the horizontal of between 10 degrees and 90 degrees. The angle of incline can be varied. In embodiments, the preferred angle of incline is substantially 45 degrees. For the majority of the processes described herein, the angle of incline has been optimized to be 45 degrees relative to the horizontal position, which corresponds to the maximum cross vector of centrifugal force in the tube and gravity. However, other angles of incline can be used including, but not limited to, 1 degree, 2 degrees, 3 degrees, 4 degrees, 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees, 41 degrees, 42 degrees, 43 degrees, 44 degrees, 46 degrees, 47 degrees, 48 degrees, 49 degrees, 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees, 71 degrees, 72 degrees, 73 degrees, 74 degrees, 75 degrees, 76 degrees, 77 degrees, 78 degrees, 79 degrees, 80 degrees, 81 degrees, 82 degrees, 83 degrees, 84 degrees, 85 degrees, 86 degrees, 87 degrees, 88 degrees, and 89 degrees.

If necessary, the angle of incline can be adjusted so as to adjust the location of the vortex that forms in the rotating tube relative to the closed end of the tube.

Optionally, the angle of incline of tube can be varied in a time-dependent way during operation for dynamic adjustment of the location and shape of the vortex.

A spinning guide or a second set of bearings assists in maintaining the angle of incline and a substantially consistent rotation around the longitudinal axis of the tube. The tube may be rotated at rotational speeds of from about 2000 rpm to about 9000 rpm.

The thin film tube reactor can be operated in a confined mode of operation for a finite amount of liquid in the tube or under a continuous flow operation whereby jet feeds are set to deliver reactant fluids into the rapidly rotating tube, depending on the flow rate.

Reactant fluids are supplied to the inner surface of the tube by way of at least one feed tube.

Any suitable pump can be used to pump the reactant fluid from a reactant fluid source to the feed tube(s).

A collector may be positioned substantially adjacent to the opening of the tube and can be used to collect product exiting the tube.

Fluid product exiting the tube may migrate under centrifugal force to the wall of the collector where it can exit through a product outlet.

The device 10 and VFD can be used in processes for exfoliating inorganic or organic materials having a graphitic like layered structure, the process comprising:
introducing a composition comprising starting inorganic or organic materials having a graphitic like layered structure and a solvent or liquid phase to a thin film reactor under conditions to form a dynamic thin film and generate shear stress within the thin film;
optionally, exposing the composition in the thin film reactor to energy from an energy source; and
processing the composition in the thin film reactor under conditions to form exfoliated inorganic or organic materials.

In one or more preferred embodiments, the inorganic or organic materials having a 2D or layered structure are selected from the group consisting of graphite, graphitic boron nitride, black phosphorus, MXene, and other 2D materials such as MoS₂ and WS₂, antimonene and clay materials. In these embodiments, the exfoliated inorganic or organic materials recovered include graphene sheets, boron nitride sheets, phosphorus black sheets, MXene sheets, graphene scrolls, and boron nitride scrolls.

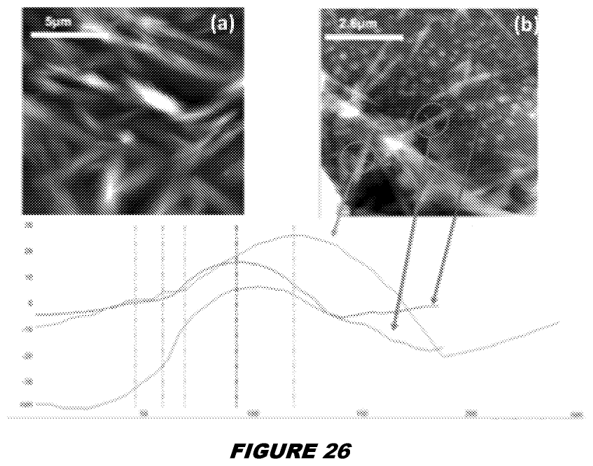

By way of example, and with reference to FIG. 26, tests have been carried out with graphene oxide (GO) dispersed in water at a number of different concentrations with each solution sonicated for 30 min to afford a black stable dispersion, noting that no scrolls were observed after sonication prior to processing in the VFD under a continuous flow rate of 0.45 mL/min in a rotating quartz glass tube 20 mm OD diameter and 18.5 cm long inclined at 45.

Optimal parameters for graphene oxide scroll (GOS) formation were 4k rpm rotational speed, laser power 250 mJ and 0.2 mg/mL concentration of GO in water. The processing involved delivering a suspension of GO to the hemispherical base of the tube in the VFD with the resulting thin film irradiated by a 5 nanosecond pulsed Q-switch Nd: YAG laser operating at 1064 nm, with an 8 mm diameter laser beam and a repetition rate of 10 Hz.

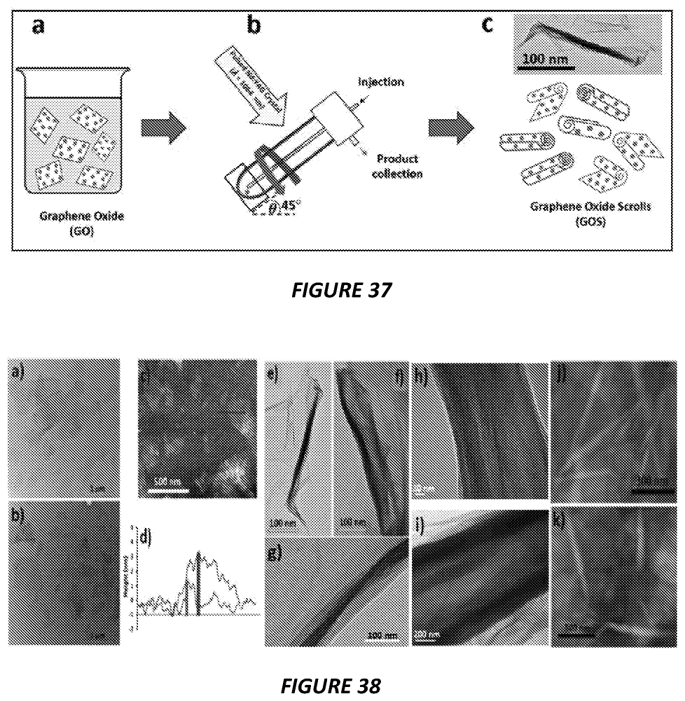

As shown schematically in FIG. 37, one or more embodiments provides process steps including: (a) Solvated GO sheets before processing in the VFD; (b) set up for the vortex fluidic device (VFD) and Nd:YAG pulsed laser irradiation (operating at 1064 nm with the optimised power at 250 mJ) and rotational speed at 4k rpm; and (c) GOS after processing in the VFD, inset is TEM image for GOS.

Optimisation of fabrication/creation of GOS: Details of the processing for transforming 2D GO sheets into 1D tubular like GOS under shear stress within a VFD are summarised in FIG. 37. GO can be dispersed in water as a stable uniform colloidal solution.

FIG. 1a schematically shows flat sheets of GO, before processing in the VFD, with FIG. 1b showing the salient features of the VFD which houses a 20 mm OD diameter quartz tube, 18.5 cm in length, inclined at 45, which is rapidly rotated with the solution irradiated with a pulsed laser operating at 1064 nm (see below discussions on optimisation studies). FIG. 1c schematically shows partially and fully scrolled GO after processing in the VFD, in accordance with the TEM images (see below).

Establishing the optimum conditions for forming GOS involved systematically exploring the parameter space of the VFD operating under continuous flow. This involved varying the rotational speed from 2k rpm to 8k rpm, followed by using different laser power, 250 mJ, 400 mJ and 600 mJ, at different flow rates of 0.1, 0.45, 1.0 and 1.5 mg/mL, and varying the concentration of GO, 0.1, 0.3 and 0.5 mg/mL.

In addition, isopropyl alcohol (IPA), as an alternative solvent which is readily removed in vacuo post processing, was also tested for GOS formation, with GO at 0.2 mg/mL, for different rotational speeds.

A flow rate of 0.45 mL/min has been established as a preferred starting point for a number of applications of the VFD with the tube fixed at 45° tilt angle which is the optimal angle for all processing using the VFD.

The optimised parameters for the highest conversion to GOS were 4k rpm with the pulsed laser operating at 250 mJ, for an aqueous suspension of GO at 0.2 mg/mL. Under these conditions there is no evidence for residual 2D GO sheets and thus the con version to GOS or partial GOS is essentially quantitative. Varying these parameters resulted in samples with significantly less GOS and partial GOS, as judged using a number of characterisation techniques.

FIG. 38 shows features of GOS derived from GO by processing the GO in the VFD. The structure of the GOS produced can be examined using transmission electron microscopy (TEM), atomic force microscopy (AFM) and scanning electron microscopy (SEM).

FIG. 38 sub figures a)-k) include examples of TEM and AFM images of GO before processing and after VFD processing, establishing the formation of GOS.

TEM and AFM images in a) to c) of FIG. 38 are for graphene GO before processing in the VFD, showing the presence of flat surfaces of GO of different sizes, which are one or more layers in thickness, according to the height profiles in the graph in d).

TEM and TFM were used to establish the nature of the scrolls—see e) to k). The tubular structure of the GOS is revealed. Different diameters range from 500 nm to a few microns. While shape of the GOS are closely uniform, the differences in diameter reflect the presence of different sizes of GO sheets in the starting material. TEM images reveal that the GOS are composed of single scrolled GO sheets or a relatively low number of graphene oxide layers, which is consistent with direct scrolling of the starting material.

Test results indicate that some of the oxygen-containing functional groups have been removed during scroll formation in the VFD in the presence of pulsed laser irradiation.

The formation of GOS from GO sheets arises from the shear stress in the complex fluid dynamics in the thin film in the VFD.

At a 45° tilt angle, the liquid is accelerated up the tube and pulled down by gravity, and there are rotational speed induced pressure waves. Coupling shear and pressure waves with induced vibrational energy in the GO sheets upon laser irradiation may facilitate the formation of the GOS.

Moreover, it would account for no further improvement in the degree of scrolling for each GO sheet upon recycling the colloidal suspension of the GOS back through the VFD at the optimised processing parameters, at the same pressure waves present at 4k rpm.

An earlier study the VFD fund that the VFD exfoliated graphite into single layer graphene sheets without the formation of any scrolls when in the absence of laser irradiation. Thus any loss of oxygen functionality at the edge of the GO sheets in the present study, under optimised VFD processing and laser irradiation, is unlikely to facilitate scroll formation.

Formation of GOS directly from GO in water in a VFD microfluidic thin film processing platform while irradiated with a NIR pulsed laser can be achieved, with the resulting product devoid of 2D GO sheets. Importantly, the processing is under continuous flow such that it can be scaled up, limited by the volume that can be delivered through a single VFD unit for a co centration of 0.2 mg/mL.

Process scale up is possible for a number of VFD units operating in parallel or in a single large VFD, or both. The versatility of the VFD is further highlighted with this new application of the device, with the operating parameters readily systematically varied in arriving at the optimised settings, under continuous flow.

The residence time of liquid entering the VFD and exiting at the top of the rotating tube is close to 11 min for a flow rate of 0.45 mL/min, such that the processing time for small volumes of water containing dispersions of GOS is short. Synthetically useful quantities of around 50 mg can be readily prepared in a single VFD.

The VFD can be used in processes for exfoliating inorganic or organic materials:

(a) Exfoliation of other 2D materials (black phosphorus, MoS2, WS2, ultrasmall antimonene dots, h-boron nitride and MXene)

### (i) Black Phosphorus

Stable dispersions of phosphorene nanosheets in isopropanol (IPA) at room temperature in the VFD.

The shear-exfoliation process can occur at a rotational speed of 6000 rpm and at a 45 degree inclination angle in the confined mode of operation for 30 minutes.

Post processing, an intense yellow dispersion of phosporene sheets was collected and centrifuged to remove any unexfoliated bulk phosphorus. AFM, TEM, HRTEM and Raman analysis establish that the phosphorene sheets were down to 4-6 layers with an average thickness of 4.3±0.4 nm.

Phosphorene sheets show promising capabilities for solar cell applications due to its thickness and tunable bandgap. Thus, we then tested the phosphorene sheets afforded in the VFD in a low-temperature processed TiO₂ photoelectrodes based planar n-i-p PSCs, yielding an efficiency of 17.85%, which was higher than that of theTiO₂-only based device, 16.35%.

### (ii) MoS2 and WS2 Sheets Under Continuous Flow

MoS2 and WS2 sheets were fabricated/created in the VFD under flow at a flow rate of 0.5 mL/min. The exfoliation occurred in IPA as the solvent, at a rotational speed of 7500 rpm and a 45 degree inclination angle. The sheets afforded were approximately 3-4 nm in thickness based on AFM analysis.

### (iii) Ultra-Small Antimonene Dots

Ultra-small antimonene with an average height and width of 2.63±0.6 nm and 30.8±2.8 nm respectively have been fabricated/created in the VFD under continuous flow.

Such an optimised process involved bulk antimony dispersed in ethanol and water at a 1:1 volume ratio (0.5 mg/mL) at a rotational speed of 7500 rpm, a 45 degree inclination angle and a simultaneous pulsed Nd:YAG laser (wavelength 1064 nm) at a laser power of 630 mJ.

The UV-Vis spectra of the solution of tellurium nanoparticles had an observed absorption peak (λ max) at 270 nm, this is slight left-shifted to the previously reported absorption peak of tellurium nanoparticles of 288 nm (for quantum dots) and 300 nm (for nanoparticles via laser ablation).

Characteristic Te-Te vibrational mode peaks (93.8, 122.4 and 140.8 cm−1) correspond within experimental error (±4 cm−1) to literature values of bulk tellurium and synthesised tellurium quantum dots and nanoparticles.

The size of the afforded tellurium nanoparticles as determined through AFM further suggests that the sample may contain quantum dots, along with a distribution of larger particles (as observed by SEM and could be overcome through optimisation of the centrifugation regime), given the complimentary data from Raman and UV-Vis analysis in comparison to current literature.

### (iv) Preparation of Laminar Tellurium Structures

As used tellurium (200-mesh) had particles which ranged in lateral dimensions from approximately 2-10 μm in size. This is of note as the structures obtained post-VFD processing, appeared with laminar, sheet-like morphologies with large lateral dimensions, ranging from 15-40 μm, a significant increase and an unreported structure.

Given the change in dimensionalities of the structures, these initial results may indicate that the process of forming these laminar structures involve the dissolution of tellurium into the solvent (water) driven by the input of both mechanical (VFD driven) and vibrational (NIR laser) energy, followed by the nucleation and growth of these particles.

Processing conditions were repeated sans laser irradiation, however no change was observed in the morphology of the bulk tellurium was observed—indicating the additional energy imparted to the system via the pulse NIR laser was required for the growth of these tellurium structures.

These laminar tellurium structures were afforded using water as the solvent (1.0 mg/mL) a rotational speed of 7500 rpm, a 45 degree inclination angle with a simultaneous pulsed Nd:YAG laser at a laser power of 260 mJ in the confined mode (30 minutes reaction time)

### (v) Crystallization of Antimony

The intense shear stress forces of antimony in NMP at room temperature under confined mode within the VFD has resulted in the crystallisation of a number of unique morphologies, previously unreported; being spicules (typical size of ˜400 nm), spheres (diameters of ˜2.3 μm) and rods (with lengths of 0.9-1.5 nm) at a noticeably high conversion rate. Not only were these particles formed at high density, but also a diverse range of sizes.

### (vi) h-Boron Nitride Sheets

The use of shear forces in dynamic thin film in the VFD can be used to exfoliate pristine h-BN in water at a concentration of 0.1 mg/mL. The optimized conditions include a rotational speed of 6000 rpm, an inclination angle of −20 degrees and a flow rate of 0.7 mL/min. Post processing, the h-boron nitride sheets were centrifuged (g=1180) to remove unexfoliated material and drop casted on a silicon wafer for further characterization.

### (vii) MXene Sheets and Spheres

MXene sheets were exfoliated in the VFD in the presence of N2 gas. This can be carried out under the continuous flow mode of operation using water as the solvent (0.5 mg/mL). The optimized experimental condition to fabricate MXene sheets includes a flow rate of 0.5 mL/min, a rotational speed of 4000 rpm at a 45 degree inclination angle.

Improved processing techniques/equipment using the VFD can provide a non-equilibrium state for the formation of scrolls in high yield.

Interfacial tension created using immiscible liquids as the solvent system is then amplified by the constant mechanoenergy generated within dynamic thin films in a microfluidic platform, such as the vortex fluidic device (VFD).

It is noteworthy that the formation of scrolls (by shearing and bending of the graphene sheets). Atomistic modelling and thermogravimetric analysis show that the scrolls are stable up to a temperature of 450° C., allowing for the exploitation of its properties at ambient and elevated temperatures.

The graphene scrolls can be electrically wired using a platinum atomic force microscope (AFM) tip in peak force tunnelling AFM and studied their conductivity relative to highly oriented pyrolytic graphite (HOPG).

HOPG serves as another form of graphene-stacking and represents a background reference such that the local conductivity of the graphene scrolls can be directly compared to the background HOPG. HOPG represents a similar material to the scrolls but has different interlayer distance and interaction between the graphene layers. Hence, the effect of the scrolling process on the conductivity can be monitored.

The VFD can be used in the essentially quantitative formation of a composite of graphene and fullerene C60, directly from graphite ore suspended in N,N-dimethylformaide (DMF) and a solution of the fullerene in specifically o-xylene, without using auxiliary substances such as surfactants which can affect surface properties of the as formed nano-material.

Suspensions of graphite in DMF were prepared at different concentrations, 1.0, 1.5, 2.0 and 2.5 mg/mL and then sonicated for 15 min, followed by centrifuged for 30 min to remove undispersed graphite.

Solutions of fullerene C₆₀ or C₇₀ were prepared in o-xylene at different concentrations, 0.5, 1.0, 1.5 and 2.0 mg/mL.

Initially, fullerene was added to the solvent and the mixtures allowed to stand at room temperature for 24 hours, whereupon they were filtered using filter paper (60 μm) to remove undissolved particles, before mixing with graphite dispersed in DMF using the VFD.

The device 10 and VFD can also be used in a process for producing graphene oxide materials, the process comprising:
introducing a composition comprising graphite and an oxidant solution to a thin film reactor under conditions to form a thin film and impart shear stress on the composition;
exposing the composition in the thin film reactor to energy from an energy source; and
processing the composition in the thin film reactor under conditions to form graphene oxide.

The oxidant solution can be an aqueous peroxide solution, such as an aqueous hydrogen peroxide solution.

The device 10 and VFD can also be used in a process for forming continuous rings of single walled carbon nanotubes (SWCNTs), the process comprising:
introducing a composition comprising starting SWCNTs of a predetermined length and a solvent or liquid phase to a thin film reactor under conditions to form a dynamic thin film and generate shear stress within the thin film;
optionally, exposing the composition in the thin film reactor to energy from an energy source; and
processing the composition in the thin film reactor under conditions to form continuous toroidal rings of SWCNTs.

Single walled carbon nanotubes (SWCNT) were discovered in 1993. These materials have attracted considerable attention from researchers due to their unique chemical and physical properties. SWCNTs have a high aspect ratio and they often grown as long tubes, the shape of SWCNT materials is largely determines their properties. Carbon nanotube (CNT) with different structures have been reported in literature as grown or post treated samples.

A variety of techniques have been reported for fabricating SWCNT rings with controlling the diameter of these rings such as the laser ablation, chemical vapour deposition (CVD). Here is shown a simple and effective way to fabricate these rings in the VFD with control over their diameter.

Firstly, SWCNTs are sliced to specific length (˜700 nm), and are converted into SWCNT rings with specific diameter (˜300 nm). Atomic force microscopy (AFM), Scanning electron microscopy (SEM) and transmission electron microscopy (TEM) were used to confirm such structure, for example by FIG. 36.

In some embodiments, the energy source is a laser. In some of these embodiments, the laser emits light at a wavelength of 1064 nm. In some of these embodiments, the laser power is from about 260 mJ to about 650 mJ.

### DESCRIPTION OF EMBODIMENTS

### Example 1—Exfoliation of Graphene Sheets Directly from Graphite Flakes in the Thin Film Processing Device of Embodiments of the Disclosure

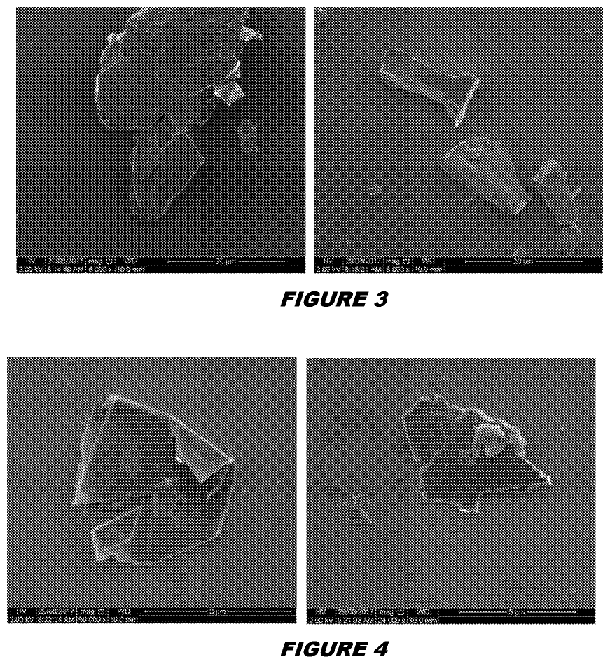

Graphite in water (10 mg/mL) was recycled 30 times through the thin film processing device shown in FIGS. 1 and 2 with the set rotational speeds of 4000 rpm (FIGS. 3) and 7000 rpm (FIG. 4). The size of the graphite flakes was reduced from the raw material. As the rotational speed of the device increased the size of the processed flakes decreased.

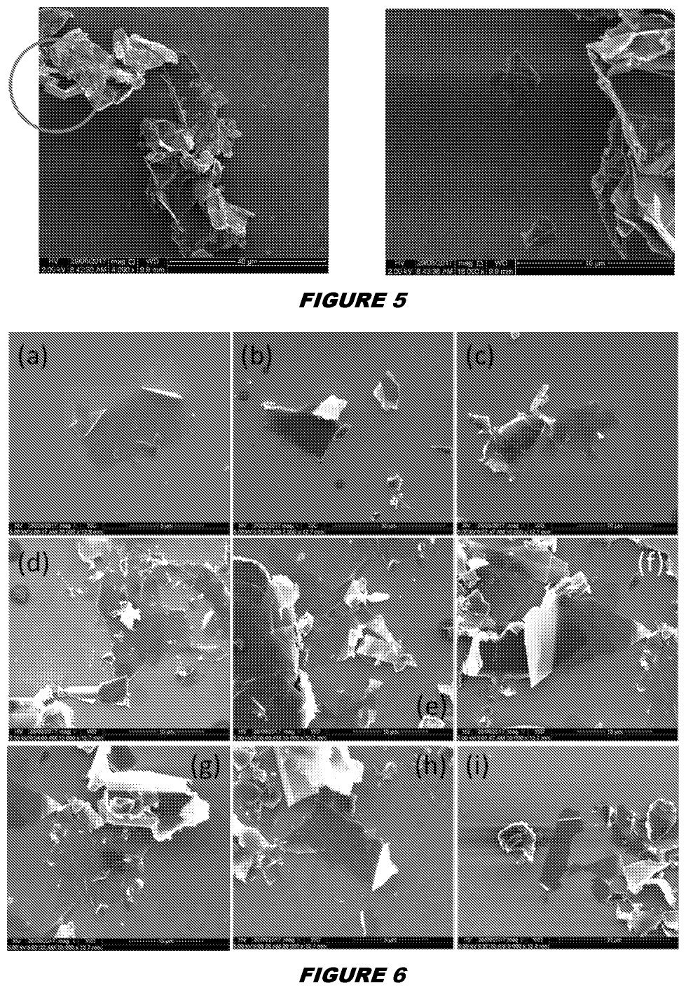

Graphite was also processed in 30% w/v aqueous H₂O₂ (10 mg/mL) in the thin film processing device shown in FIGS. 1 and 2. The rotational speed was 7000 rpm, and the solution was recycled through the device 30 times. The results are shown in FIG. 5 where it can be seen that shear-induced delamination and sheet fracturing has occurred to produce smaller and thinner sheets of graphitic material. There are also structural changes at the edges of the graphite.

### Example 2—Exfoliation of Graphene Sheets Directly from Graphite Flakes

Graphene sheets were produced directly from graphite flakes in the VFD under the following conditions:
Solvent: mixture of isopropanol and water (1:1 volume ratio)
Flow rate: 1 mL/min (4 passes)
VFD conditions: 45 degree inclination angle, 8000 rpm rotational speed
Nd:YAG laser conditions: 260 mJ laser power (pulsed)

Graphene sheets with an average thickness of approximately 6-7 nm were fabricated in the VFD under continuous flow in the presence of IPA and water at a 1:1 volume ratio. The exfoliation occurred in the presence of shear stress in the VFD and with a pulsed Nd:YAG laser providing extra energy to facilitate the exfoliation process. The yield of exfoliation is approximately 60%.

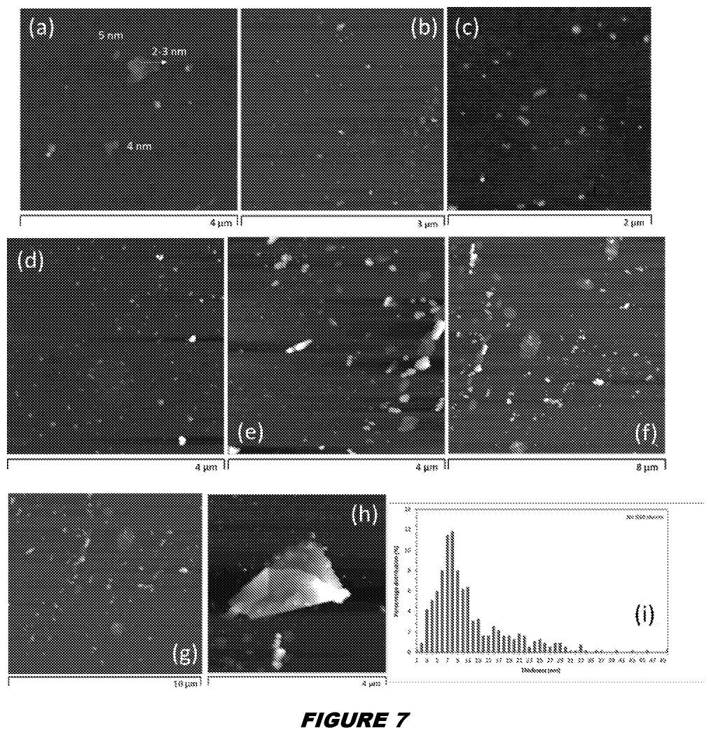

The results are shown in FIGS. 6, 7 and 8.

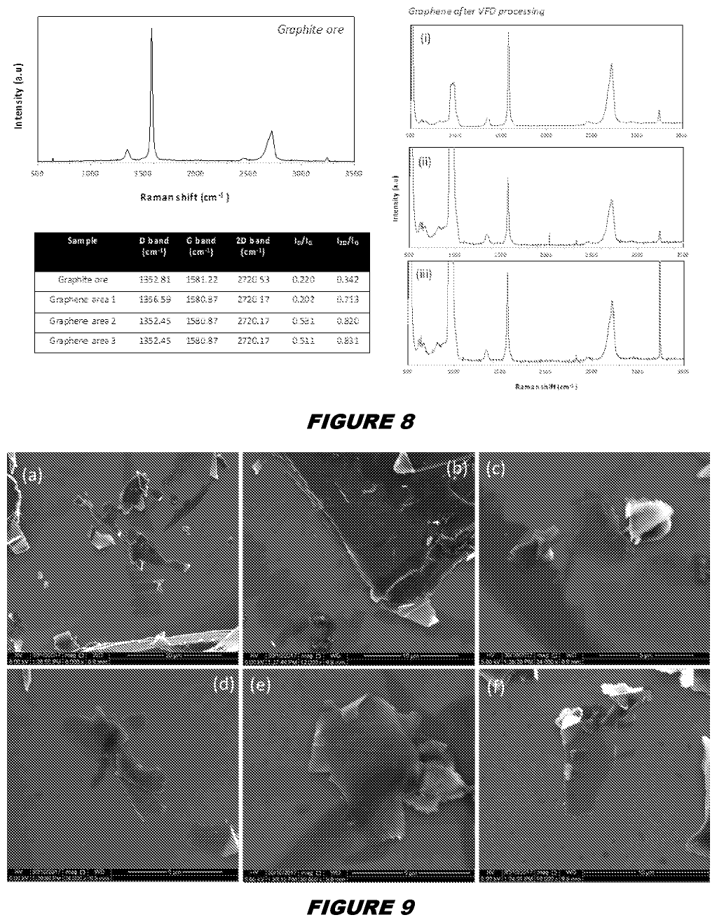

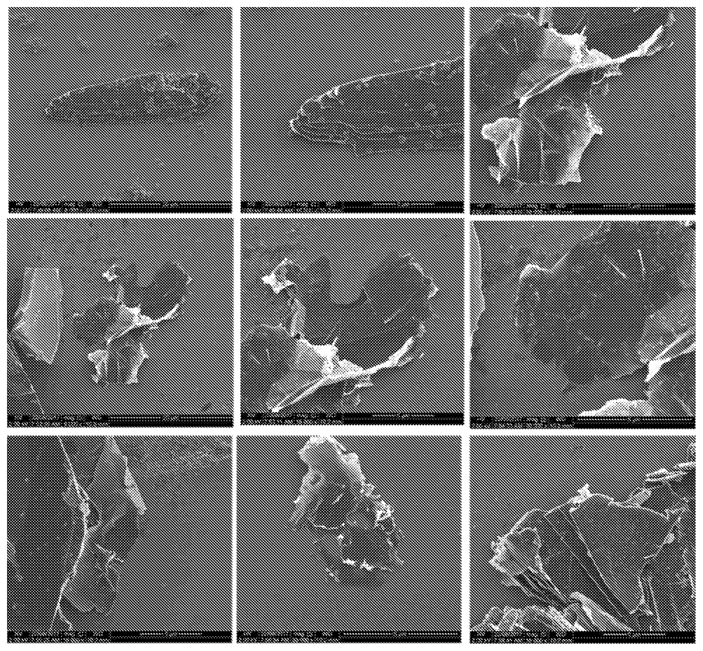

As an alternative, the same process was carried out using an infrared lamp as the light source as an alternative to the pulsed Nd:YAG laser. The results are shown in FIG. 9.

### Example 3—Fabrication of Graphene Oxide in the Presence of Aqueous Hydrogen Peroxide (30%)

Graphene oxide was produced in the presence of 30% aqueous hydrogen peroxide in the VFD under the following conditions:
Concentration: 1 mg/mL
Solvent system: 30% hydrogen peroxide (H₂O₂)
Nd:YAG laser (λ=1064 nm): Laser power 260 mJ
VFD parameters: 45° inclination angle and 7500 rpm rotational speed

Graphene oxide was fabricated using 30% aqueous H₂O₂ as the environmentally benign oxidant to functionalise the surface of graphene sheets. A rotational speed of 7500 rpm was chosen as the optimized rotational speed as high yield of exfoliated graphene sheets was observed at this speed. A laser power of 260 mJ was employed for the purpose simultaneously oxidizing the surface of the graphene sheets.

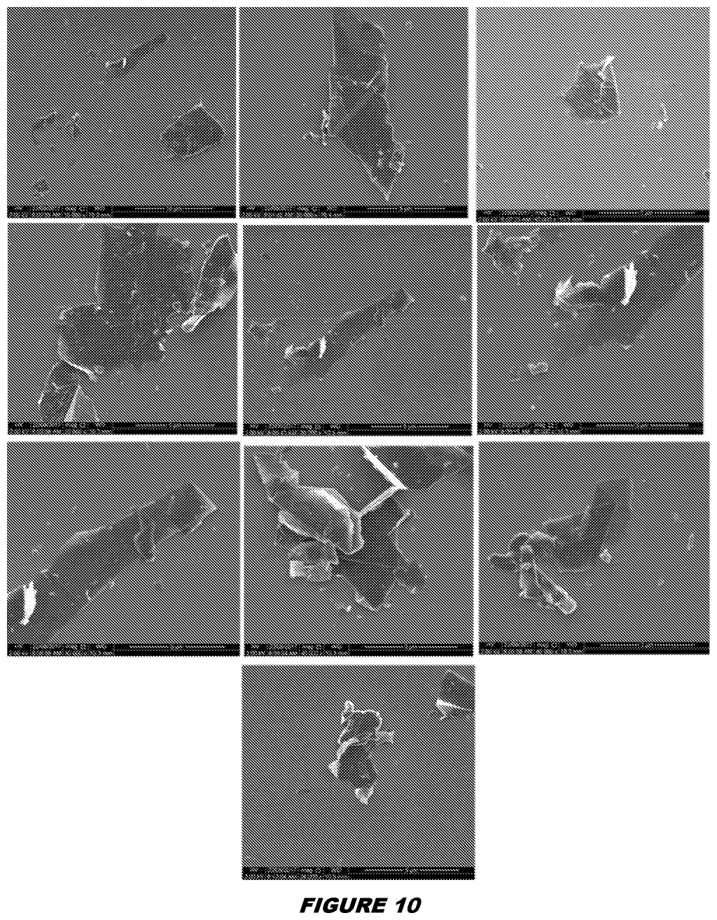

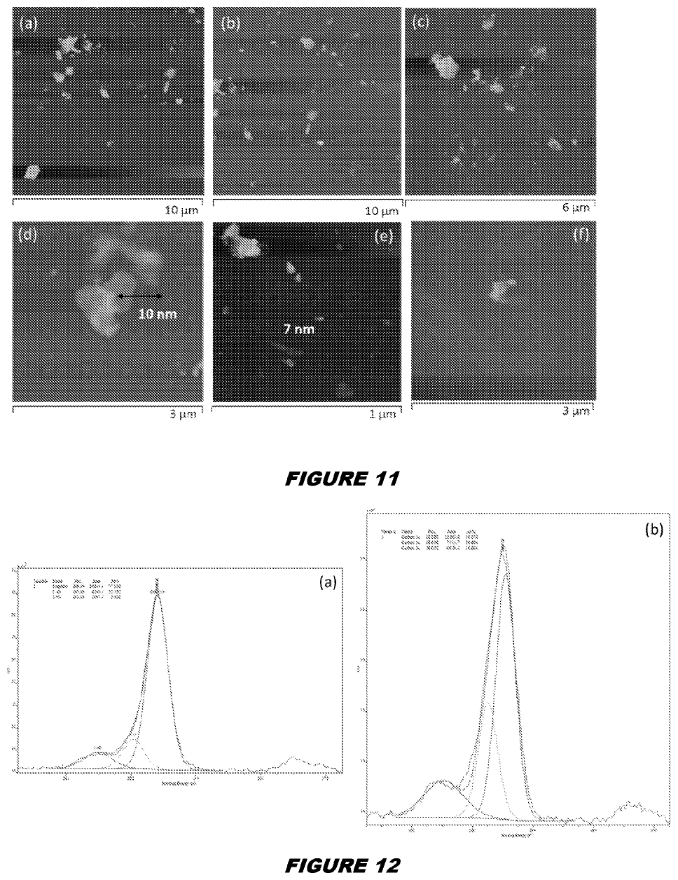

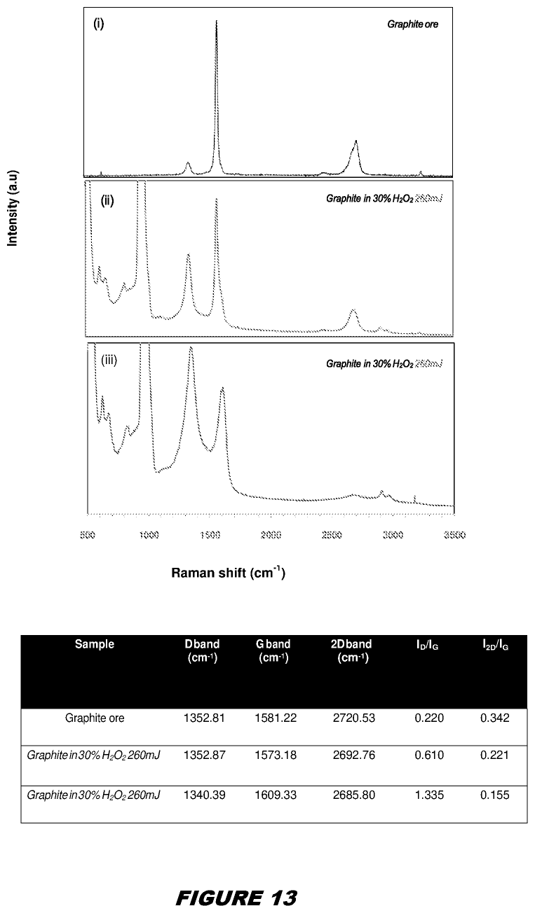

The results are shown in FIGS. 10, 11, 12 and 13.

Example 4—Controlling the Oxidation on the Surface of the Graphene Sheets in Aqueous Hydrogen Peroxide (30%) by Varying the Laser Power

Graphene oxide was fabricated using H₂O₂ as the environmentally benign oxidant, in functionalising the surface of graphene sheets as set out in Example 3. It is evident that a high concentration of hydroxyl free radicals is formed upon exposure to laser irradiation (1064 nm). Different laser powers were employed for the purpose of controlling the extent of oxidation on the basal planes and edges of the graphene sheets.

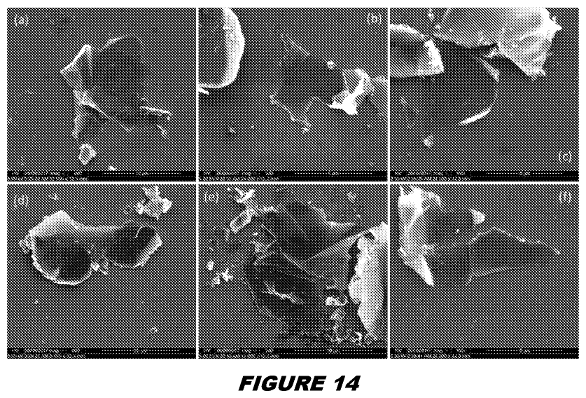

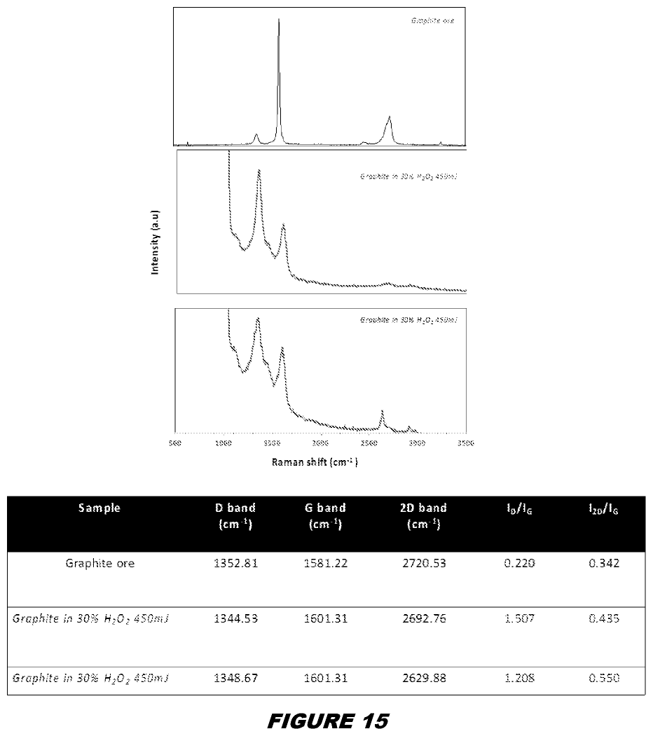

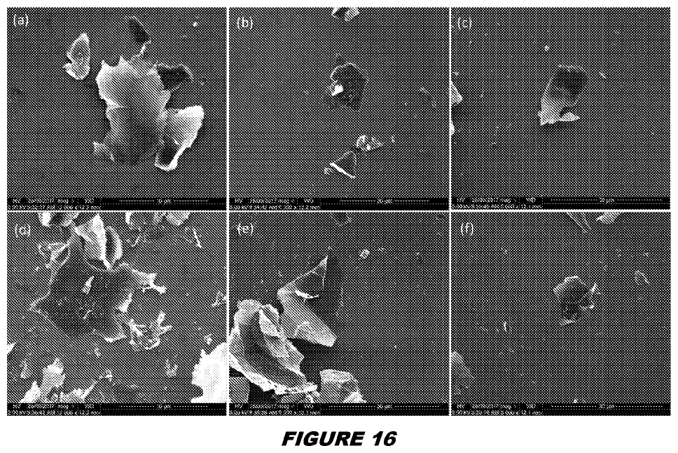

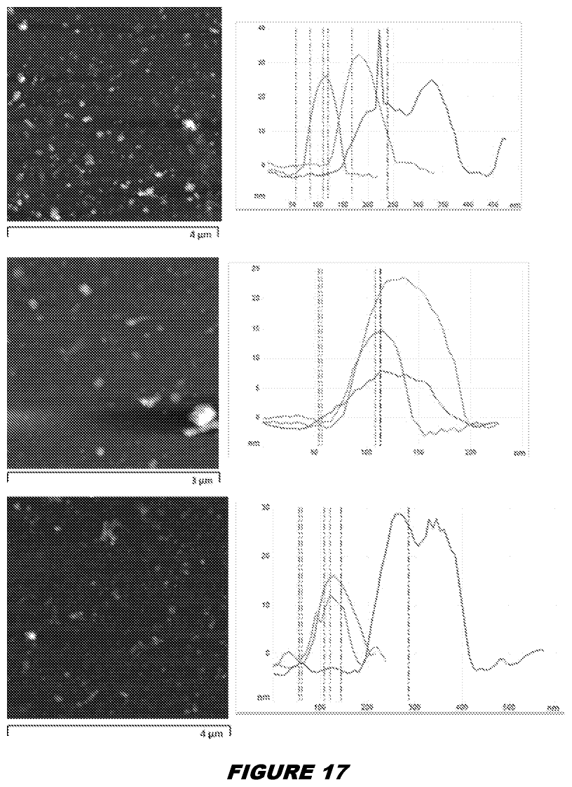

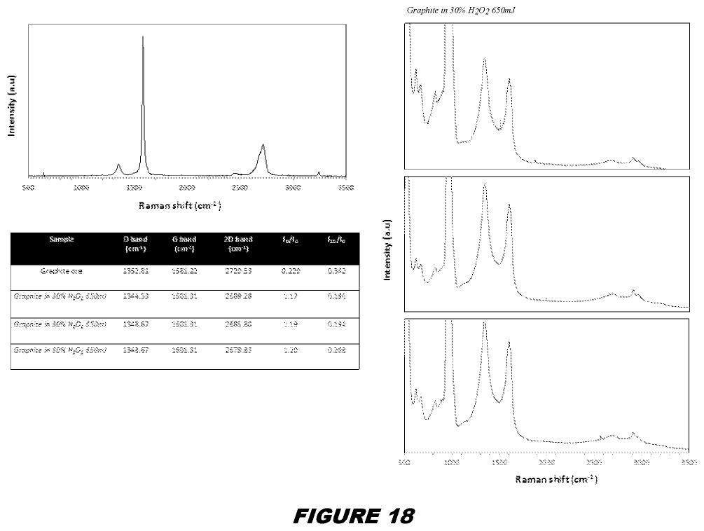

The results are shown in FIGS. 14, 15, 16, 17 and 18.

### Example 5—Exfoliation of Boron Nitride Sheets from Graphitic Boron Nitride

Graphitic boron nitride (h-BN) sheets were exfoliated in the VFD under the following conditions:
6000 rpm.
Flow rate: 0.7 mL/min.
h-BN: 0.1 mg/mL in water.
The angle at −20°.

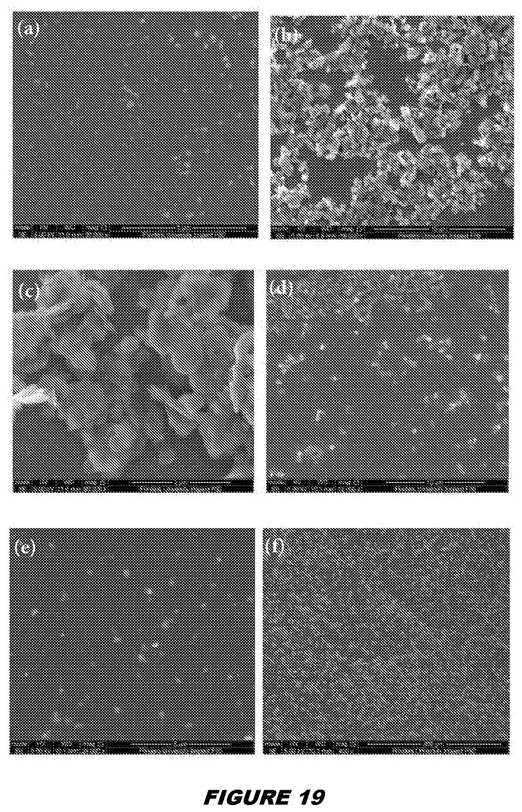

Herein shear forces in dynamic thin film in a vortex fluidic device (VFD) were used to exfoliate pristine h-BN. The rotation speed for a 20 mm glass tube is 6000 rpm with angel −20° and flow rate of the solution h-BN (0.1 mg/mL in water) at 0.7 mL/min, FIG. 19. The exfoliated h-BN may be used as quantum emitters and for drug or protein delivery.

The results are shown in FIG. 19.

### Example 6—Fabrication of Graphene Scrolls Directly from Graphite Flakes

Shear stress within the dynamic thin film in a VFD affords compact graphene nanoscrolls in 30% yield, in the absence of surfactants and other chemical stabilising agents. The optimized conditions are for a rapidly rotating glass tube inclined at 45° relative to the horizontal position containing a specific volume of a mixture of toluene and water. This is the confined mode of operation of the device, with the different fluid dynamic response under continuous flow ineffective.

Two dimensional (2D) graphene sheets have captured the attention of the research community due to their exquisite electrical, thermal and mechanical properties, and associated diversity of applications. Graphene has a high Young's modulus (˜1.100 GPa) yet in some cases it can roll up to form graphene scrolls of varying compactness.

Less extreme flexibility is evident, for example, in wrapping graphene around fullerene C₆₀ molecules, the direct formation of 3D fullerenes from single layered graphene sheets, the conversion of nitrogen doped reduced graphene oxide (rGO) sheets into nanoscrolls by decoration with magnetic nanoparticles, and the inclusion of self-assembled molecules inside the scrolls.

Access to rolled up one dimensional graphene scrolls is important in exploiting their dual properties of both carbon nanotubes and graphene sheets, as well as exhibiting more enhanced carrier mobility and mechanical strength.

Although graphene scrolls possess a tubular structure as for carbon nanotubes, they have more specific applications, especially in hydrogen storage and in supercapacitors, with the interlayer spacing within the scrolled graphene sheets being tunable, depending on the scrolling mechanism.

A variety of methods have been reported for exfoliating graphene sheets and their conversion to graphene scrolls of various lengths, which depend on the dimensions of the precursor graphite flakes. However, these either afford composite materials or afford scrolls in low yield in bulk samples.

The challenge is to be able to gain access to graphene scrolls in high yield, ideally avoiding the use of damaging forms of mechanoenergy, for example when using long periods of sonication, which can limit the applications.

Other challenges relate to avoiding the need for adding auxiliary reagents such as fullerene C₆₀, scroll enhancing magnetite nanoparticles, and other molecules.

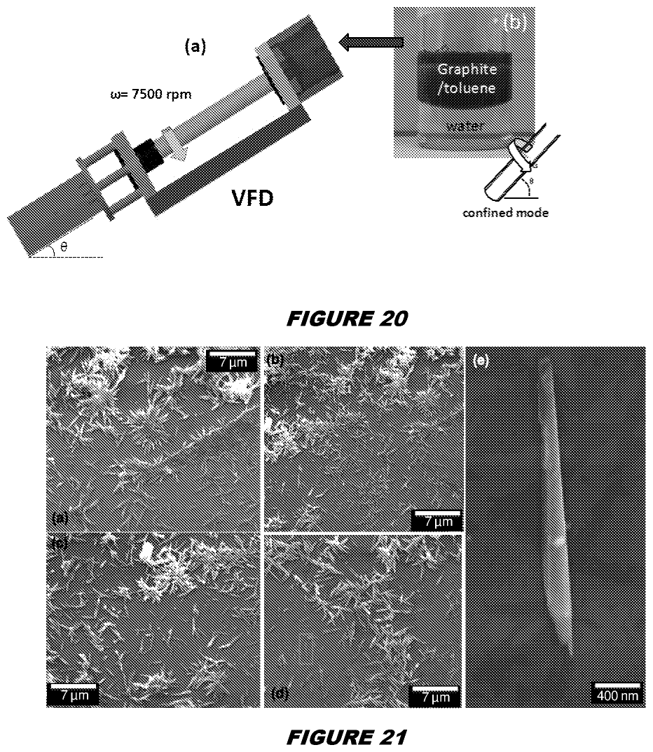

We have developed a simple one step method under ambient conditions for fabricating stable graphene scrolls directly from graphite flakes in 30% yield. This involves the use of high shear in a mixture of toluene and water in the confined mode of operation of the vortex fluidic device (VFD), FIG. 20, in the absence of the above auxiliary reagents.

The confined mode has a glass tube, typically 20 mm OD, rapidly rotating at w 2k to 9k rpm, containing a specific volume of liquid, and titled at θ 45° relative to the horizontal plane as the optimal angle for a number of applications. Scroll formation arises from the expected liquid-liquid interfacial tension created from micro-mixing of immiscible liquids.

The VFD can also operate under the preferred continuous flow mode where jet feeds constantly deliver liquid to the bottom of tube or at positions along it. However, has reduced effectiveness in forming graphene scrolls under certain conditions studied, further highlighting the utility of the VFD in process development, by varying the mode of operation, along with other operating parameters such as rotational speed and tilt angle.

The confined mode of operation of the VFD generates a thin film for a specific volume of liquid within the tube, which is 1 mL in the present study. Importantly there is a minimum threshold speed w, which is required to maintain a vortex to the bottom of the tube, otherwise there are different regimes of shear within the liquid. This operation of the VFD are effective for a diversity of applications of the device. These include exfoliation of graphene and boron nitride in N-methylpyrollidinone (NMP), generating mesoporous silica at room temperature with control of pore size and wall thickness, generating graphene algae hybrid material for nitrate removal, formation of toroidal arrays of SWCNTs, controlling the self-assembly of fullerenes, controlling chemical reactivity and selectivity in organic synthesis, controlling the polymorphs of calcium carbonate, protein folding, and probing the structure of self-organized processes.

In a typical experiment, graphite flakes (1 mg, particles size 7-10 pm in lineal dimension of the planar flakes) was dispersed in toluene (0.5 mg/mL). MilliQ water (0.5 mL) was then added to the graphite/toluene dispersion (0.5 mL) in the 17.7 mm internal diameter VFD borosilicate glass tube (20 mm external diameter). The volume ratio of the graphite/toluene dispersion to water was optimised at 1:1 as ratios other than the equal ratio afforded minimal scrolls. The optimum confined mode VFD operating parameters for generating high yield graphene scrolls were θ at 45° and rotational speed set at 7500 rpm for a reaction time of 30 minutes. Centrifugation (g=3.22) of the post-processed material removed any residual graphite flakes and contaminants present in the sample. The scrolls were stable in solution with minimal amount of unexfoliated/scrolled graphite flakes, with an estimated percent conversion of ca 30%. This is a 30-fold increase relative to using the related high shear spinning disc processor (SDP), which operates only under continuous flow, and using NMP as the solvent. Also noteworthy is that the use of the SDP also give irregular shaped scroll which have been buckled, unlike the scrolls in the present study.

Control experiments established that the concentration of the starting materials was critical for the highest level of formation of graphene scrolls with the minimal concentration to be of 0.1 mg/mL. The maximum concentration of the initial graphene/toluene dispersion was optimised to be of 0.5 mg/mL with higher concentrations, for example 5.0 mg/mL affording much lower yields, ˜10% or with no scrolls observed. This could be related to the high concentration of starting material perturbing the complex fluid dynamics which is effective for scroll formation. The ratio of the two solvents was optimized, with an equal volume ratio of toluene and water yielding the aforementioned 30% yield. Volume ratios other than the optimised afforded exfoliated graphene sheets, with little or no nanoscrolls observed.

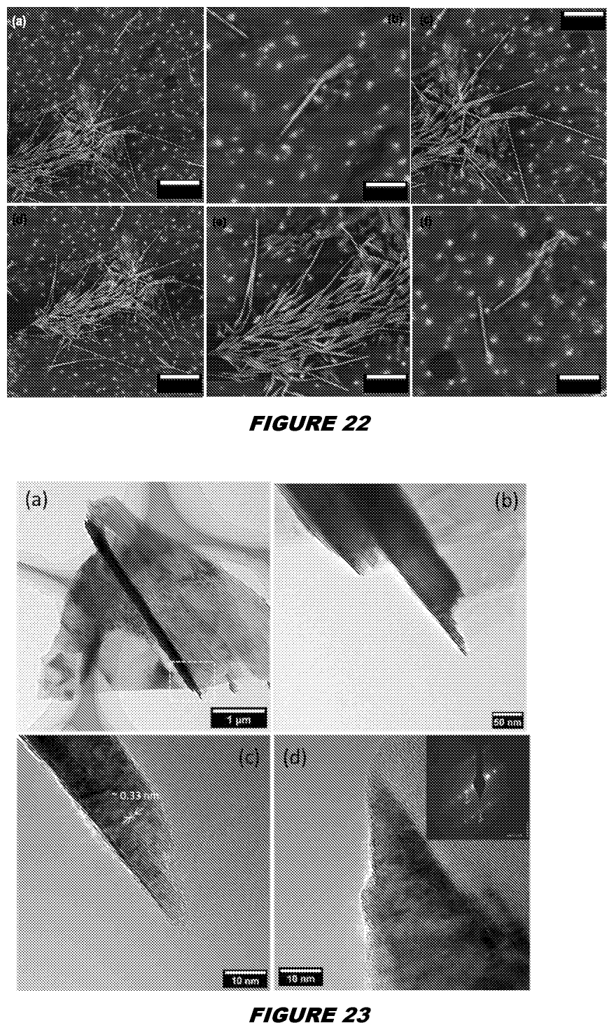

Scroll formation of graphene scrolls was established by scanning electron microscopy (SEM), atomic force microscopy (AFM) and transmission electron microscopy (TEM) (FIGS. 21, 22 and 23).

The lengths of the scrolls appear to be pre-determined by the cross section dimensions of the precursor graphite flakes, established to be between 2 to 5 μm in length (SEM and TEM) with a height between 10-30 nm (AFM). The scrolls resemble the structural appearance of multi-walled carbon nanotubes (MWCNT).

Interestingly MWCNTs can be sliced down to ca 170 nm in the VFD with the optimised conditions using a 1:1 mixture of NMP and water, at w 7.5 k rpm and θ 45° in the confined mode, as well as in continuous flow, while irradiated with a pulsed YAG laser operating at 1064 nm and 260 mJ. Under the same conditions, there was no evidence for slicing the preformed scrolls, and the same was also for laser irradiation in situ during the scroll formation. In addition, laser irradiation did not affect the overall yield of scroll formation.

The lack of lateral slicing of the scrolls in NMP and water rules out the unlikely formation of MWCNTs, despite their similar appearance in SEM and AFM.

Lateral slicing of the scrolls requires the breaking of a continuous array of carbon-carbon bonds across a micron or more, as a higher energy process relative to breaking a limited number of such bonds in slicing carbon nanotubes within carbon nanotubes.

The scrolls are compact and relatively uniform in length and diameter, which is consistent with rolling up of the graphene sheets from graphite intact.

In contrast, the compact graphene scrolls formed in the spinning disc processor (reaction) are associated with shredding and ripping of the graphene sheets in forming much shorter length scrolls regardless of the dimensions of the starting material.

The mechanism of exfoliation and simultaneous scrolling of graphene sheets in the present work relates to a combination of both the controllable mechanoenergy generated within the dynamic thin films in the VFD and the presence of the interfacial tension arising from now using an immiscible solvent system. The shear forces would enable the dispersed graphite flakes to accelerate rapidly up the tube by the large centrifugal force and then downwards creating Stewartson/Ekman layers within the dynamic thin film. The large shear forces within the VFD may result in local bending of the edges of the upper layers of the flakes which is further facilitated in the presence of the otherwise immiscible solvent system, toluene and water.

Control experiments established that changing the volume ratio of toluene to water resulted in partial scroll formation or no scrolls, with further evidence of exfoliation of the graphene sheets. Thus, the lifting/bending of the graphene sheets is facilitated by the interfacial tension coupled with the shear stress in the VFD enabling the end of the graphene sheets to form a close contact with the inner surface of the graphene sheets, overcoming the large van der Waals forces between the sheets and thus spontaneous scrolling occurs. The HRTEM image in FIG. 23(c) establishes that the graphene nanoscrolls have an interlayer spacing of ˜0.33 nm which is at the van der Waals limit.

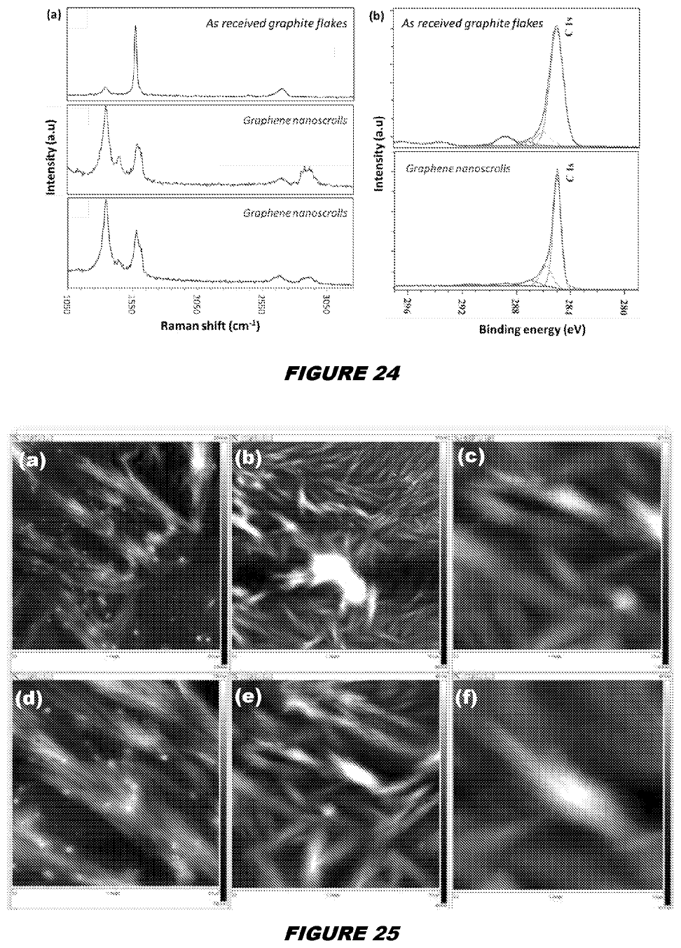

Conformal Raman mapping (FIG. 24a) of the processed samples deposited on SiO₂/silicon substrates were able to confirm the presence of the graphene nanoscroll structures, rather than unlikely MWCNTs for which they resemble in lateral length and cross section. The Raman spectra of the graphene nanoscrolls show a typical graphitic spectrum, D band (1338.2 cm⁻¹), G band (1574.7 cm⁻¹) and a 2D band (2678.4 cm⁻¹).

A significant increase in the averaged Raman ID/IG ratio (corresponding to the D-band and G-band intensities) of the nanoscrolls compared to the as received graphite flakes were observed to be approximately 0.99 and 0.58 respectively, suggesting a significant increase in the density defects of the scroll structures which can be well attributed to the scrolled edges.

A red shift of the G band (˜20.8 cm⁻¹) was prominently observed for the nanoscrolls which is often related to the increasing number of graphene layers and disoriented stacked layers of graphene within the structures.

As the graphene sheets scroll up, changes of the C—C bond and phonon dispersion shifts the G band.

A broadening of the G band from the activation of the doubly degenerate zone centre E2g phonon mode was also consistent with scroll formation having a broader full width of half maximum (FWHM) observed within a range of 40 cm⁻¹ to 90 cm⁻¹ compared to pristine graphite flakes which was approximately 20 cm⁻¹.

The increase in the broadness is due to π-π interactions between stacked graphene scrolls.

The broadening of the G band was consistent with the blue shift of the 2D band which also coincides with the formation of graphene nanoscrolls.

The Raman spectra of the graphene nanoscrolls were easily distinguishable from small diameter SWCNTs, from the absence of splitting of the G peaks into 2 degenerate modes, G+ and G−. This indicates that despite the high tensile strain of the graphene nanoscrolls, the confinement and curvature of these scroll structures have no significant effect on the carbon-carbon intra-atomic force constants.

Other than prominent peaks corresponding to the graphitic material, additional peaks were observed in the Raman spectra at approximately 1436 cm⁻¹ and 2870 cm⁻¹.

Control experiments were able to assign the position and the shape of peaks to the silicon substrate and the residual traces of solvents (toluene/water) on the surface of the nanoscrolls.

The chemical states of elements of the graphene nanoscrolls in comparative to the as received graphite flakes were then investigated by XPS (FIG. 24b).

The deconvolution of the C1s peak which is assigned to the sp2 carbon atoms afforded four other peaks corresponding to sp3 C, C—O, C═O and O═C—O respectively which could be due to the edges and defects on the graphite flakes. A slight decrease in oxygen content was observed from the decrease in the O═C—O content and increase in the C—O and C═O content in the graphene nanoscrolls post VFD processing.

Thermogravimetric analysis (TGA) analysis of the graphene nanoscrolls post VFD processing showed weight losses with the corresponding heat flow vs. temperature at a heating rate of 10° C./min up to 800° C.

The TGA results suggest that on heating the scrolls are under strain, reaching a critical point whereby they erupt into graphene sheets.

In conclusion, we have developed a facile one-step method of fabricating graphene nanoscrolls, which are formed under high shear generated within the dynamic thin film in a vortex fluidic device.

The graphene scrolls are stable below 450° C. and were produced in 30% isolated yield, in the absence of auxiliary surfactants, nano-materials, and other chemicals, with minimal processing times. While the processing is restricted to confined mode of the VFD, scaling up will be possible through robotic control whereby aliquots of water and graphite dispersed in toluene are added to the VFD tube and removed by draining through tilting post shearing.

The inability of continuous flow to generate scrolls is in contrast to scrolls being formed using a spinning disc processor under continuous flow, but with only 1% yield. This further highlights the utility of the VFD in processing nanomaterials, adding to a growing number of other applications.

### Example 7—Fabrication of Graphitic Boron Nitride Scrolls

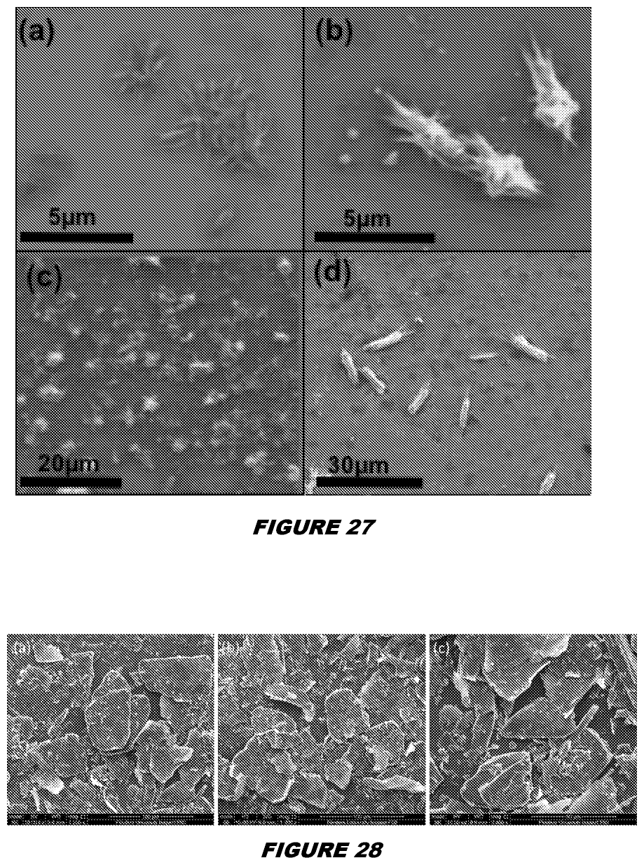

Graphitic boron nitride (h-BN) scrolls were generated in the thin film in VFD with a 20 mm OD glass tube inclined at −45° and rotating at 6000 rpm, with a flow rate of h-BN solution in water (0.1 mg/mL) at 0.3 mL/min, FIGS. 25, 26 and 27; the height of the h-BN scrolls between 10-40 nm.

The results are shown in FIGS. 25, 26 and 27.

### Example 8—Shear Mediated Fabrication of Phosphorene from Black Phosphorus

The use of layered 2D materials in electronic applications in particular, has sparked the interest for the continuous search for new materials that exhibit more exciting properties than that of graphene and transition metal dichalcogenides (TMDs) for potential applications.

Over the years, graphene and molybdenum disulfide (MoS₂) have been vastly exploited for their superior mechanical, electrical and optical properties and have without a doubt created new avenues for device applications in the post silicon era.

Recently, a new found material, black phosphorus (BP), the most thermodynamically stable phosphorus allotrope has gained significant amounts of attention in materials science owing to its intriguing properties.

Albeit the continuous development in the use of graphene and other 2D layered materials for electronic applications, phosphorene the bulk counterpart of black phosphorus is foreseen to bridge the gap between graphene and the TMDs with the combination of its high flexibility, high carrier mobility and tunable band gap.

Similar to graphite, BP is made of a layered structure held together by van der Waals interactions. Its band gap varies between 0.3 eV for the bulk and 2 eV for monolayer phosphorene.

There have been significant efforts to exfoliate single to multi layered phosphorene typically involving the mechanical cleavage and liquid exfoliation method. The challenges that are endured include the scalability of the process while taking into consideration the sensitivity of the material when exposed to oxygen and water.

Thus, we have developed a novel method which includes the use of shear stress generated within dynamic thin films in a microfluidic platform, the vortex fluidic device (VFD) and a pulsed Nd:YAG laser to fabricate phosphorene directly from bulk phosphorus. In a typical experiment, black phosphorus was dispersed in isopropanol (7 mg/mL) whereby 1 mL was then placed in the 17.7 mm internal diameter VFD borosilicate glass tube (20 mm external diameter) in the confined mode of operation.

The operating conditions for generating phosphorene sheets of approximately 2-6 nm in thickness were 8 at 45° and rotational speed set at 8000 rpm for a reaction time of 30 minutes and a laser power of ˜260 mJ. Centrifugation (g=3.22) of the post-processed material removed any residual black phosphorus flakes and contaminants present in the sample.

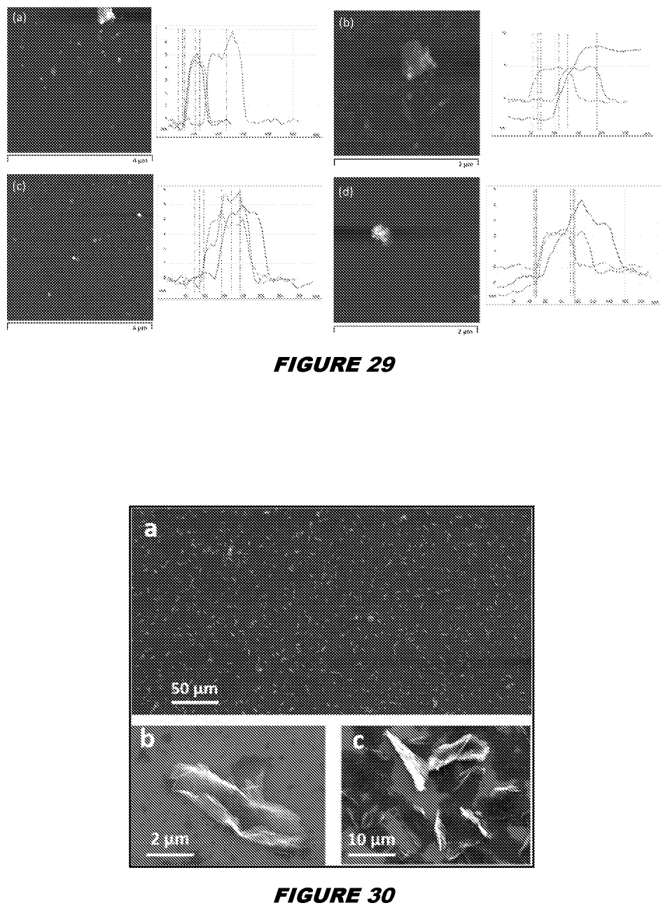

The results are shown in FIGS. 28 and 29.

### Example 9—Production of Graphene Oxide Scrolls

In recent years, graphene scrolls (GSs) have taken researchers attention because they are one dimension (1D) tubular topology.

GSs can be formed be rolling up graphene sheets, thus give them an excellent properties like other carbon materials such as high thermal and electrical conductivities and excellent mechanical properties.

Due to their special properties, GNSs can be used in many applications such as hydrogen storage, supercapacitors, and electronic devices.

Graphene oxide was processed in the VFD under the following conditions to form graphene oxide scrolls:
Solvent: water
Flow rate: 0.45 mL/min
VFD conditions: 45 degree tilt angle, 4000 rpm rotational speed
Nd:YAG laser conditions: 250 mJ laser power (pulsed)

Scanning electron microscopy, atomic force microscopy and transmission electron microscopy measurements confirmed the scrolled conformation of graphene oxide sheets. The results are shown in FIGS. 30 and 31.

Thus, we have established a simple and efficient method to form graphene oxide scrolls from graphene oxide in water within dynamic thin films in the VFD under continuous flow.

Example 10—Production of Graphene Spheres in the VFD Under Continuous Flow, in Toluene and DMF in the Presence of Fullerene C60

Graphite was mixed with fullerene C60 with the help of a VFD. The process involved the use of various VFD methods and incorporated the use of green chemistry metrics that are processed under continuous flow.

Different techniques will be employed in the examination and determination of its potential utilization in various multifarious applications. The resulting novel structure has undergone fabrication without the use of any harsh chemical solvent or surfactant as a means of ensuring that there is a minimal influence of the subsequent technology on the surroundings and guarantees the safety of the process.

Firstly, fullerene C60 with concentration of 0.5 ml/ml were dissolved in toluene, the mixture left overnight at room temperature, after that the samples filtered to remove undissolved particles. On the other hand, 1 mg of graphite were dissolved in DMF, and sonicated for 20 min. The samples were then mixed together by using continues flow VFD techniques. The mixture was injected into the rapidly rotating tube 20 mm (glass tube) through a jet fed. Rotation speed was 4k rpm, tilt angle was 45 and flow rate was 0.5 ml/min.

The mixture comprising C60 and graphite was processed in the VFD under the following conditions:
Continuous flow
Concentration of graphite 1 mg/mL.
Concentration of fullerene C60 is 0.5 mg/ml
θ=45°
ω=4 krpm.
\dot{v}=0.5 mL/min.
Room temperature

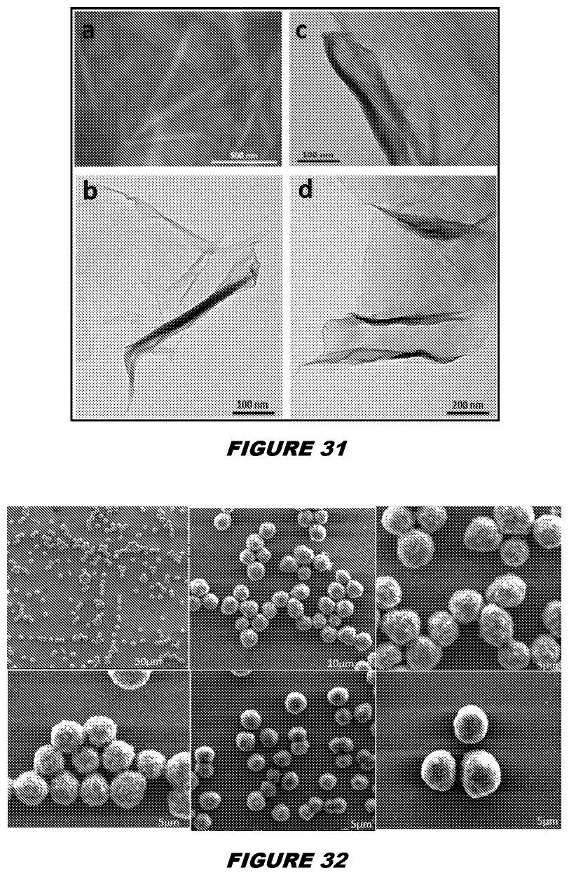

The results are shown in FIG. 32.

### Example 11—Scrolling of Graphite by Using Vortex Fluidic Device VFD

Use of the VFD technique in scrolling of graphite is a quick method, and it is considered a chemical free and environmentally friendly. The fabrication process involves the inducement of shear stress on Nano carbons and entails the use of new forms of Nano carbons.

The ability to use the VFD method in the production of graphite scrolls through the application of supercapacitors and gas storage as well as the ability to slice carbon nanotube without using anti-solvent or waste generating chemicals in a controlled manner is vital in the investigation of the scope needed to develop short carbon nanotube vital in drug delivery applications.

Flask graphite at a concentration of 0.1 mg/qA was suspended in dimethylformamide (DMF), and sonicated for 20 min before VFD processing. The samples were injected into the rapidly rotating tube (glass tube) rotating at 4 k rpm and 7k rpm, with a flow rate was 0.5 mL/min. tilt angle 45 degree. All experiments were at room temperature with the VFD used under continuous flow mode.

The conditions used were:
Continuous flow
Concentration of graphite 0.1 mg/mL.
Solvent: Dimethylformamide (DMF).
θ=45°.

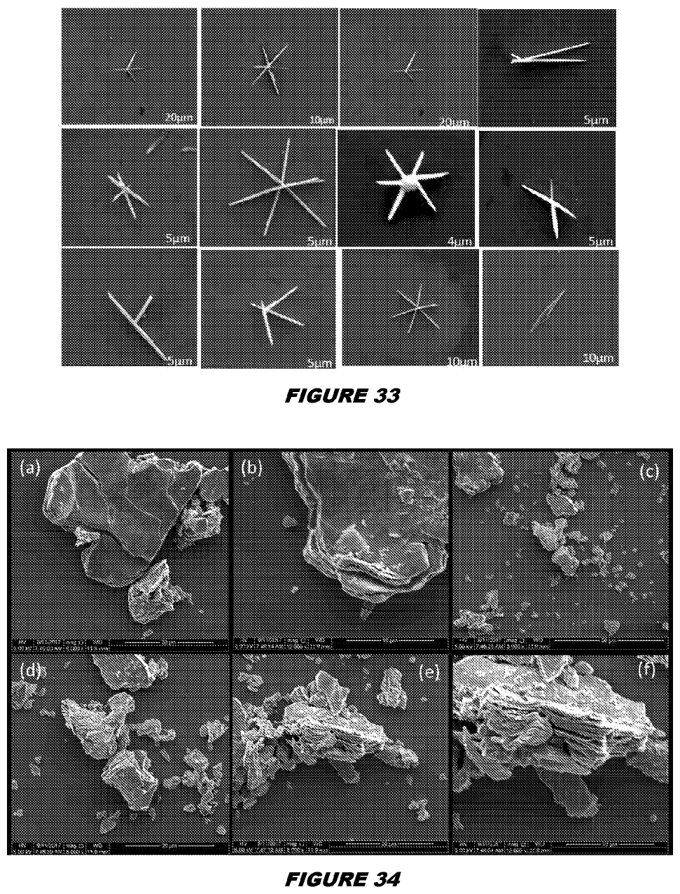

The results are shown in FIG. 33.

### Example 12—Exfoliation of MXene

MXene sheets were fabricated in the VFD at a rotational speed of 8000 rpm using isopropyl alcohol and water at a 1:1 volume ratio. A simultaneous pulsed laser with a laser power of 260 mJ was directed at the rapidly rotating tube.

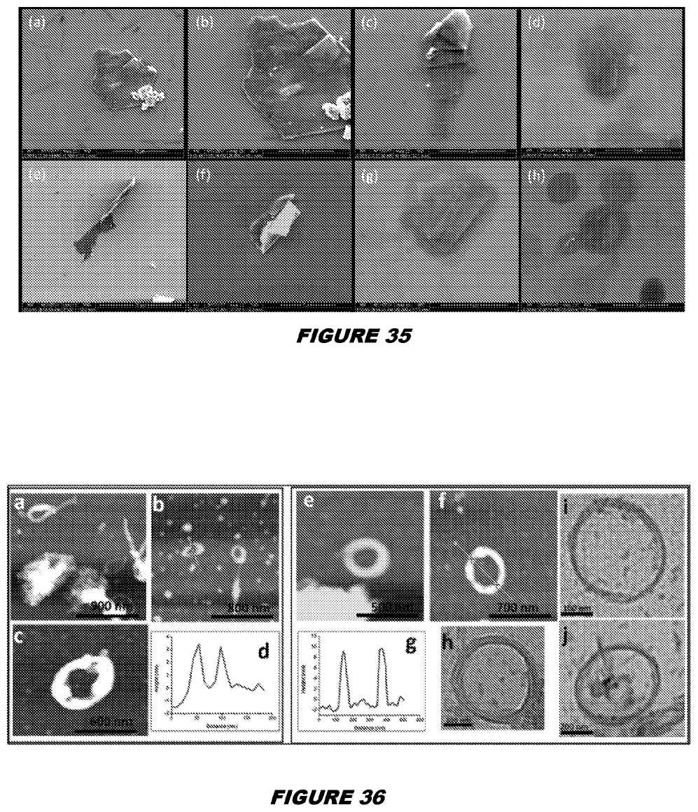

The results are shown in FIGS. 34 and 35.

### Example 13—SWCNT Nanorings Structure

Single walled carbon nanotube (SWCNT) nanorings were fabricated by using the shear stress generated in a VFD. They were fabricated from sliced SWCNTs (˜700 nm) previously formed in the VFD under continuous flow conditions, and they had diameters around 300 nm, after pulsed laser irradiates at 100 mJ under confined mode, although conversion to continuous flow is anticipated.

The conditions used were:
Solvent: Toluene/water (1:1) in the confined mode
VFD conditions: 45 degree tilt angle, 7500 rpm rotational speed
Nd:YAG laser conditions: 100 mJ laser power (pulsed).

The results are shown in FIG. 36.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein.

It will be appreciated that the invention is not limited to the embodiment or embodiments disclosed, but is capable of numerous rearrangements, modifications and substitutions without departing from the scope of the invention as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the invention

1. A process for producing nanostructure materials in a thin film reactor from inorganic or organic material having a layered or two dimensional (2D) structure or from inorganic material transformed in situ into 2D inorganic material or from single walled carbon nanotubes (SWCNTs), the process comprising:
providing in the thin film reactor a composition including:
an inorganic or organic starting material having a layered or 2D structure or single walled carbon nanotubes (SWCNTs), or
transforming in situ a said inorganic material into a said 2D inorganic starting material,
and a solvent or liquid phase;
forming a dynamic thin film of the composition in the thin film reactor;
generating shear stress within the thin film;
under controlled conditions applied to the thin film of the composition within the thin film reactor, forming a desired nanostructure material.

2. The process according to claim 1, wherein the starting material includes graphite or graphitic material.

3. The process according to claim 2, wherein the nanostructure material includes graphene or graphene oxide.

4. (canceled)

5. (canceled)

6. The process according to claim 1, including exposing the composition in the thin film reactor to energy from an energy source, and processing the composition in the thin film reactor under conditions to form exfoliated inorganic or organic materials.

7. (canceled)

8. (canceled)

9. (canceled)

10. (canceled)

11. (canceled)

12. The process according to claim 1, wherein the solvent or liquid phase includes an oxidant.

13. The process according to claim 12, wherein the oxidant includes an aqueous peroxide solution.

14. The process according to claim 1, wherein the starting material includes the single walled carbon nanotubes (SWCNTs), the process including:
introducing the composition including the SWCNTs and the solvent or liquid phase to the thin film reactor under conditions to form the dynamic thin film and generate shear stress within the thin film;
and
processing the composition in the thin film reactor under the conditions to form continuous toroidal rings of the SWCNTs.

15. (canceled)

16. (canceled)

17. The process according to claim 1, wherein the starting material includes black phosphorus and the resulting nanostructure material includes phosphorene.

18. The process according to claim 1, further including exfoliation of the 2D or layered starting material within the thin film reactor.

19. The process according to claim 18, wherein the exfoliation occurs simultaneously with creation of the desired nanostructure material.

20. The process according to claim 1, the process including transforming the inorganic starting material into a 2D or layered inorganic material in situ in the thin film device prior to or during the process steps of forming the desired nanostructure material.

21. The process according to claim 1, wherein the thin film reactor is a vortex fluidic device (VFD) or a device including a first fluid contact surface and a second fluid contact surface spaced from the first fluid contact surface by a distance corresponding to a desired thin-liquid film thickness and rotatable with respect to the first fluid contact surface about an axis of rotation, a liquid supply means configured to deliver a liquid between the first fluid contact surface and the second fluid contact surface so that, in use, the liquid contacts the first and second fluid contact surfaces and forms a thin liquid film of desired thickness therebetween, and relative rotation between the first and second fluid contact surfaces drives the liquid away from the axis of rotation and creates shear stress within the thin liquid film.

22. A device for forming thin-liquid films under high shear stress, the device including a first fluid contact surface and a second fluid contact surface spaced from the first fluid contact surface by a distance corresponding to a desired thin-liquid film thickness and rotatable with respect to the first fluid contact surface about an axis of rotation, a liquid supply means configured to deliver a liquid between the first fluid contact surface and the second fluid contact surface so that, in use, the liquid contacts the first and second fluid contact surfaces and forms a thin liquid film of desired thickness therebetween, and relative rotation between the first and second fluid contact surfaces drives the liquid away from the axis of rotation and creates shear stress within the thin liquid film.

23. The device of claim 22, wherein the first fluid contact surface is on a stationary base of the device and the second fluid contact surface is on a rotor of the device.

24. The device of claim 22, wherein the rotor includes at least one blade.

25. The device of claim 24, wherein the at least one blade diverges from the second contact surface inward of the rotor toward the axis of rotation.

26. The device of claim 22, wherein the rotor has at least one opening through a wall thereof for the liquid to flow from the space to the second fluid contact surface.

27. The device of claim 26, wherein the at least one opening is formed by separation of a respective wall section from the wall.

28. The device of claim 27, wherein the respective wall section is a curved wall section projecting into an interior of the rotor of the wall

29. The device of claim 22, wherein the second fluid contact surface has a cone profile.

30. The device of claim 22, wherein the first fluid contact surface has a hollow cone profile to receive the second fluid contact surface therein at the spaced distance.

31. The device of claim 22, wherein the liquid supply means is configured to provide the liquid into a space between the axis of rotation and the second fluid contact surface.

32. The device of claim 22, wherein the liquid supply means includes an injector.

33. The device of claim 22, further including at least one flowpath for receiving the liquid driven from between the first fluid contact surface and the second fluid contact surface.

34. The device of claim 22, wherein the first fluid contact surface and the second fluid contact surface maintain the distance within the range of 50 μm to 500 μm.

35. The device of claim 34, wherein the distance is between 75 μm and 250 μm or between 100 μm and 200 μm.

36. (canceled)

37. The device of claim 22, wherein the first fluid contact surface and/or the second fluid contact surface is at an angle of between 0° and 90° with respect to the axis of rotation.

38. The device of claim 37, wherein the angle is between 20° and 60° or is substantially 45° from the axis of rotation.

39. (canceled)

40. The device of claim 22, wherein relative motion of the first fluid contact surface and the second fluid contact surface is between 100 rpm and 10,000 rpm.

41. (canceled)

42. (canceled)

43. The device of claim 22, wherein the liquid includes a composition of inorganic or organic material having a layered or two dimensional (2D) structure or inorganic material subsequently transformed in situ in the device into 2D inorganic material or single walled carbon nanotubes (SWCNTs).

44. A nanostructure material formed by a process according to claim 1.

45. The nanostructure material of claim 44, wherein the nanostructure material includes at least one of graphene, graphene oxide, phosphorene, SWCNTs, scrolls, tubes, spheres and rings.

46. (canceled)
